(19) United States
(12) Patent Application Publication
(10) Pub. No.: US 2026/0344569 A1
(43) Pub. Date: Nov. 5, 2026

(54) SINGLE PASS HARVESTER FOR WHOLE PLANT CROPS

(71) Applicant: Ohio State Innovation Foundation, Columbus, OH (US)

(72) Inventors: Scott SHEARER, Columbus, OH (US); Andrew KLOPFENSTEIN, Columbus, OH (US); Nate PARSONS, Columbus, OH (US); Ajay SHAH, Columbus, OH (US)

(21) Appl. No.: 19/124,587

(22) PCT Filed: Oct. 26, 2023
(86) PCT No.: PCT/US23/77940

§ 371 Date: Apr. 25, 2025

Related U.S. Application Data
(60) Provisional application No. 63/419,542, filed on Oct. 26, 2022.

(51) Int. Cl. A01D 43/08; A01B 59/042; A01D 69/00

(52) U.S. Cl. CPC A01D 43/081; A01B 59/042; A01D 43/086; A01D 69/002

(57) ABSTRACT

A whole-plant harvester including a swing hitch including a box section including a plurality of mounting holes configured to receive a pintle hitch configured to couple to a tractor, a main beam rigidly coupled to the box section, and a frame bracket including side plates and a plurality of horizontal plates rotatably coupled to the swing hitch. A baler is rigidly coupled to the side plates of the frame bracket so that the baler can rotate relative to the main beam, the baler including baler intake portion for intaking whole-plant crops and a baler output portion for outputting bales of whole-plant crops. A harvester header pivotably coupled to the swing hitch and movable vertically relative to the baler. The harvester header includes one or more drums for cutting and gathering whole-plant crops and a head output portion for outputting the cut and gathered whole-plant crops.

### CROSS-REFERENCE TO RELATED APPLICATIONS

This application claims the benefit of U.S. Provisional Patent Application No. 63/419,542, filed on Oct. 26, 2022, the entire contents of which are incorporated herein by reference.

### STATEMENT OF GOVERNMENT SUPPORT

This invention was made with government support under grant number 2019-67019-29310 awarded by the United States Department of Agriculture. The government has certain rights in the invention.

### BACKGROUND

This disclosure relates to harvesting equipment. More specifically, this disclosure relates to whole plant crop harvesting.

### SUMMARY

In some aspects, the techniques described herein relate to a whole-plant harvester including: a swing hitch including a box section configured to couple to a tractor, a frame bracket, and a main beam rigidly coupled to the box section and pivotably coupled to the frame bracket; a baler rigidly coupled to the frame bracket, the baler including baler intake portion for intaking whole-plant crops and a baler output portion for outputting bales of whole-plant crops; an upper header mount coupled to the baler; a linear actuator coupled to the baler; and a harvester header pivotably coupled to the upper header mount and coupled to the linear actuator, the harvester header including one or more drums for cutting and gathering whole-plant crops and a head output portion for outputting the cut and gathered whole-plant crops, wherein the harvester header is coupled to the baler such that the head output portion feeds whole-plant crops directly into the baler intake portion.

In some aspects, the techniques described herein relate to a swing hitch for a whole-plant harvester, the swing hitch including: a box section including a plurality of mounting holes configured to receive a pintle hitch configured to couple to a tractor; a main beam rigidly coupled to the box section; and a frame bracket configured to engage a baler, the frame bracket including side plates providing space for rotation of the baler relative to the main beam, and a plurality of horizontal plates rotatably coupled to the swing hitch.

In some aspects, the techniques described herein relate to a whole-plant harvester including: a swing hitch including a box section including a plurality of mounting holes configured to receive a pintle hitch configured to couple to a tractor; a main beam rigidly coupled to the box section; and a frame bracket including side plates and a plurality of horizontal plates rotatably coupled to the swing hitch. a baler rigidly coupled to the side plates of the frame bracket so that the baler can rotate relative to the main beam, the baler including baler intake portion for intaking whole-plant crops and a baler output portion for outputting bales of whole-plant crops; and a harvester header pivotably coupled to the swing hitch and movable vertically relative to the baler, the harvester header including one or more drums for cutting and gathering whole-plant crops and a head output portion for outputting the cut and gathered whole-plant crops.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF DRAWINGS

The device is explained in even greater detail in the following drawings. The drawings are merely exemplary and certain features may be used singularly or in combination with other features. The drawings are not necessarily drawn to scale.

FIG. 1 is a graph of maize grain production in the U.S. from 1999 to 2019.

FIG. 2 is a perspective view of a baler with a rotor cutter preprocessor, according to some implementations.

FIG. 3 is a perspective view of a header arranged in a folded position for transport, according to some implementations.

FIG. 4A is a perspective view of the header of FIG. 3 including a mounting frame, according to some implementations.

FIG. 4B is a perspective view of the header of FIG. 3 without the mounting frame, according to some implementations.

FIG. 5 is a perspective view of the header of FIG. 3 positioned at a throat of the baler of FIG. 2, according to some implementations.

FIG. 6 is a perspective view of an upper header mount, according to some implementations.

FIG. 7A and FIG. 7B are perspective views of another upper header mount, according to some implementations.

FIGS. 8A-C are perspective views of a finite element analysis (FEA) of the header mount of FIG. 6, according to some implementations.

FIG. 9A and FIG. 9B are perspective views of an FEA of a header mount tube of the header mount of FIG. 6, according to some implementations.

FIG. 10 is a perspective view of a lower header mount fitted with hydraulic cylinders which in turn are supported at an undercarriage front axle, according to some implementations.

FIG. 11A and FIG. 11B are perspective views of an undercarriage spacer and a corresponding FEA, according to some implementations.

FIG. 12A and FIG. 12B are perspective views of a baler suspension before (FIG. 12A) and after inversion (FIG. 12B), according to some implementations.

FIG. 13 is a perspective view of the baler of FIG. 2 and the header of FIG. 3 on a weight measurement system, according to some implementations.

FIG. 14 is a schematic representation of a simplified baler frame and hitch model, according to some implementations.

FIG. 15 is a schematic representation of a loading of a baler frame-hitch beam model at the hitch point (left end), according to some implementations.

FIGS. 16A-C are perspective views of an FEA of mechanical tube sizing (16-inch by 12-inch by 0.50-inch) for sizing and fabrication of a swing hitch, according to some implementations.

FIG. 17 is a perspective view of a hitch tongue weldment assembly, according to some implementations.

FIG. 18 is a perspective view of a baler hitch/frame connection weldment, according to some implementations.

FIG. 19 is a perspective view of a swing hitch positioning pin, according to some implementations.

FIG. 20 is a perspective view of a swing hitch and frame attachment, according to some implementations.

FIG. 21 is a front view of a middle plate for the hitch/frame connector weldment of FIG. 20, according to some implementations.

FIG. 22A and FIG. 22B are front views of an FEA of a hitch/frame connector weldment upper and lower horizontal plate, according to some implementations.

FIG. 23 is a graph of Danfoss TMT 250 hydraulic motor performance curves, according to some implementations.

FIG. 24 is a perspective view of a hydraulic motor mount for the header, according to some implementations.

FIG. 25A and FIG. 25B are front views of an FEA on the hydraulic motor mount of FIG. 24, according to some implementations.

FIG. 26 is a side view of a power-take-off (PTO) driveline configuration for the swing hitch of FIG. 20, according to some implementations.

FIG. 27 is a perspective view of the baler of FIG. 2 lifted for undercarriage reconfiguration, according to some implementations.

FIG. 28 is a perspective view of the baler of FIG. 2 with a reconfigured undercarriage for greater ground clearance, according to some implementations.

FIG. 29 is a perspective view of the hitch of FIG. 20 installed on the baler of FIG. 2, according to some implementations.

FIG. 30 is a perspective view of the baler of FIG. 2 with the swing hitch of FIG. 20 in a transport position, towed by a tractor, according to some implementations.

FIG. 31 is a perspective view of the baler of FIG. 2, with the swing hitch of FIG. 20 in an offset position, towed by the tractor, according to some implementations.

FIG. 32 is a perspective view of the header of FIG. 3 positioned well ahead of a throat of a stuffer chamber of the baler of FIG. 2, according to some implementations.

FIG. 33 is a perspective view of another header mount at the baler frame, according to some implementations.

FIG. 34 is a perspective view of the header mount of FIG. 33, according to some implementations.

FIG. 35A and FIG. 35B are perspective views of an FEA of the header mount of FIG. 33, according to some implementations.

FIG. 36 is a perspective view of a baler frame and swing hitch connection superstructure, according to some implementations.

FIG. 37 is a perspective view of an assembled whole plant maize harvester in an offset configuration for field harvest operations, according to some implementations.

FIG. 38 is a perspective view of the whole planter maize harvester of FIG. 37, according to some implementations.

FIG. 39 is a perspective view of field testing of the whole plant maize harvester of FIG. 37, according to some implementations.

FIG. 40 is a chart showing a whole plant field investigation layout, according to some implementations.

FIG. 41 is a plot of tractor path for a whole plant maize plant harvest, according to some implementations.

FIG. 42 is a plot of a tractor path for whole plant maize harvest including bale locations, according to some implementations.

FIG. 43 is a perspective view of a post-harvest distribution of whole plant maize bales in a field, according to some implementations.

FIG. 44 is a graph showing single pass maize harvest bale weight vs. length, according to some implementations.

FIG. 45 is a chart showing hydraulic performance obtained from OECD Test Report, according to some implementations.

FIG. 46 is a graph showing cyclic PTO and hydraulic power requirements for a whole plant portion of Block 3 harvest, according to some implementations.

FIG. 47 is a graph showing cyclic PTO and hydraulic torque requirements for a whole plant portion of Block 3 harvest, according to some implementations,

FIG. 48 is a graph showing a distribution of power requirements for a whole plant portion of Block 3 Harvest, according to some implementations.

FIG. 49 is a graph showing a distribution of power requirements for a whole plant portion of Block 3 Harvest, according to some implementations.

FIG. 50 is a perspective view of a draper header with outboard gauge wheels, according to some implementations.

FIG. 51 is a schematic representation of a sum of force and moment for an offset hitch configuration of the whole plant harvester, according to some implementations.

### DETAILED DESCRIPTION

Following below are more detailed descriptions of concepts related to, and implementations of, methods, apparatuses, and systems for a single pass harvester for whole plant crops. Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

To shift the United States' energy use towards renewable sources, whole-plant crop harvest is an invaluable tool in feedstock procurement for cellulosic and ligno-cellulosic ethanol production. Several studies have been conducted into whole-plant maize harvest using multiple passes throughout the field or by using a combination of agricultural equipment pieces simultaneously to complete the operation. Disclosed herein are methods, devices, and systems for single-pass whole-plant maize harvesters that are developed to be pulled by a large frame (>300 hp) tractor to cut and bale the crop. To achieve this goal an omni-directional forage header is mated to a large rectangular baler with additional modifications assembled including an undercarriage redesign, forage header mount, and a swing-style hitch with power-take-off (PTO) driveline. The developed hitch allows the whole-plant harvester to track in an offset configuration from the tractor, ensuring that the maize crop (or another crop type) can be harvested without being run over by the tractor. In some implementations, the harvester requires an average of 130 PTO hp though peak loads can occur as high as 310 PTO hp or more. The whole-plant harvester produces large rectangular bales with an average density of 21.5 lbs/ft3, surpassing the density needed to overload semi-trailers of 13.5 lbs/ft3. Harvest rates have been demonstrated to range from 14.8-15.4 ton/ac based on the standard deviation of bale weight. The harvester simplifies logistics of a whole-plant maize harvest and produces bales dense enough to make the transportation of the crop more viable for the grower.

Various implementations include a tool for harvesting whole-plant crops. The tool includes a forage harvester head, a baler, and an off-set hitch. The forage harvester head includes one or more drums for cutting and gathering whole-plant crops and a head output portion for outputting the cut and gathered whole-plant crops. The one or more drums cuts and gathers whole-plant crops, gathers the cut material, and delivers the whole-plant material to the intake chamber of the baler. The baler has a baler intake portion for intaking whole-plant crops and a baler output portion for outputting bales of whole-plant crops. In some implementations, the baler intake portion is a bale chamber for forming high density bales which are discharged from the rear of the baler. The forage harvester head is coupled to the baler such that the head output portion feeds whole-plant crops directly into the baler intake portion. Further, the head mounting fixture allows the head to rotate about a horizontal axis normal to the direction of travel of the tractor enabling changes in crop cut height. The swing-style hitch couples the baler and the forage harvester head combination to a tractor.

As the United States seeks to further its energy independence while striving to expand renewable energy usage it is increasingly important to target biofuels. Since 2005 the United States has mandated the volume of advanced and cellulosic biofuels as well as biodiesel, however, as a nation we have never met the required production threshold for cellulosic biofuels. In 2018 the EPA required 288 million gallons of cellulosic biofuels while only 6.54 million gallons were produced (Nuelle, 2019). These biofuels are produced from multiple agricultural residues though maize stover is the most effective and promising feedstock for future production. Maize stover harvest and logistics is one of the challenges that needs to be overcome on the road to commercialization of cellulosic biofuels.

Maize stover is an ideal energy source due to its high concentrations in cellulose and hemicellulose which are carbohydrate polymers. Maize Stover is traditionally comprised of 38-40% C6H10-O5 (cellulose) and 28-31% C5H10O5 (hemicellulose), while also having a 7-21% lignin content. Cellulose is a polymer comprised primarily of glucose, while hemicellulose is mostly xylose. Both glucose and xylose are highly fermentable sugars allowing for high ethanol yields to be produced from maize stover. The process for converting cellulose to glucose and hemicellulose to xylose vary from each other however. In fact, optimal conversion processes for one sugar often inhibit the conversion of the other. This is a significant hurdle that must be overcome in the commercialization of cellulosic ethanol.

Traditionally, maize stover is harvested in multiple passes after grain harvest is completed via windrowing and baling. In a recent Farm Bureau report (Meyers, 2020) estimates that the United States planted over 92 million acres of maize in 2020 (para. 1). A maize plant is comprised of individual kernels (grain) as well as a cob, tassels, leaves, roots, husk, and the stalk. Everything besides the grain is considered as agricultural residue and is referred to as stover. On a weight basis there is nearly a one-to-one ratio between maize grain and maize stover (DOE, 2016).

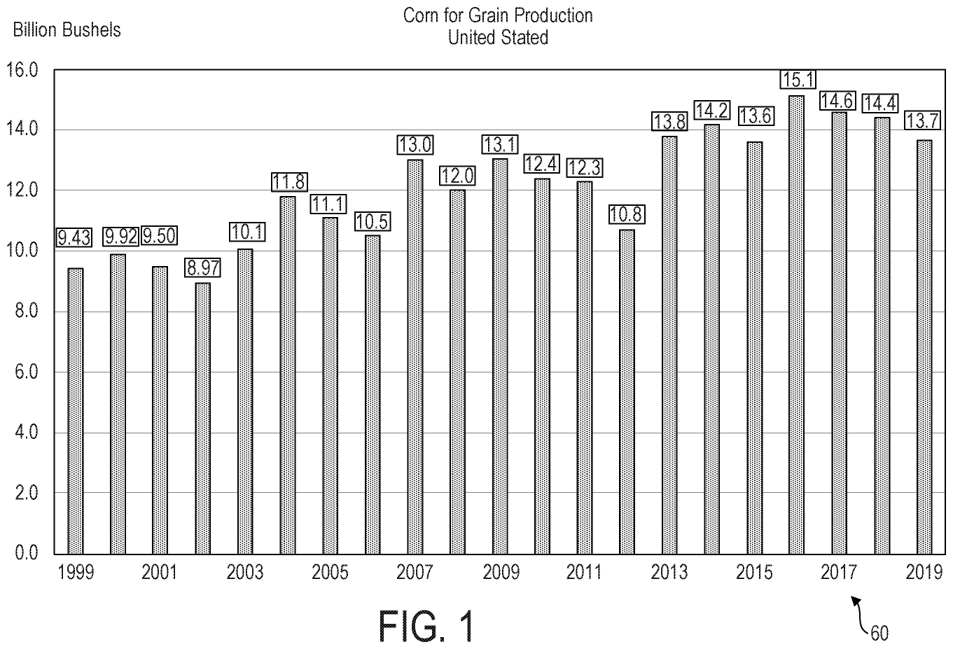

FIG. 1 shows a graph 60 of maize grain production in the United States in billions of bushels. A marketable bushel of maize weighs 56.0 lbs. assuming a moisture content of 15.5% wet basis. Given the one-to-one ratio, almost 385 million tons of both maize grain and stover were produced in 2019. A ton of maize stover can produce approximately 85 gallons of cellulosic ethanol. Therefore, in 2019 a theoretical 32.6 billion gallons of cellulosic ethanol could have been produced. Clearly, there is enough maize stover to supply the feedstock demand for cellulosic biofuels in the U.S., however, a primary concern is the cost-effective harvest and delivery of high-quality feedstocks to the biorefinery.

Logistically, whole-plant maize harvest is a difficult task due to the multiple steps required and the costs of transportation. One factor in reducing system costs lies in bale density. Bale density is a large factor due to fixed transportation costs. Semi load costs are based upon fuel usage and miles driven, not upon the load itself traditionally, unless a specialty or oversized load is transported.

Other concerns revolve around the correct amount of stover to remove from the field in order to maximize ethanol production and cost savings, while minimizing the agronomic hazards that occur with this process.

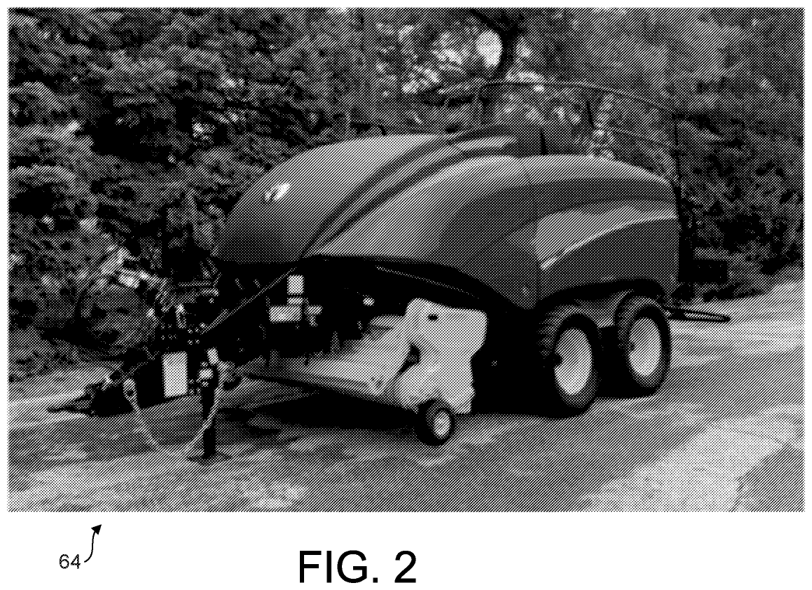

As shown in FIG. 2, a whole-plant maize harvester 62 discussed herein includes a baler 64. The baler 64 forms large square bales primarily of hay, straw, or sileage, though in the case of this project a different crop type was utilized. In some implementations, the bales have a cross sectional dimension of three feet in height by four feet in width and have operator selectable lengths ranging from 3.94 up to 8.20 feet.

The baler 64 is equipped with tandem axles, and a steerable rear axle. The baler 64 can also include a monitor that displays machine diagnostics and an automatic greasing system which lubricates components.

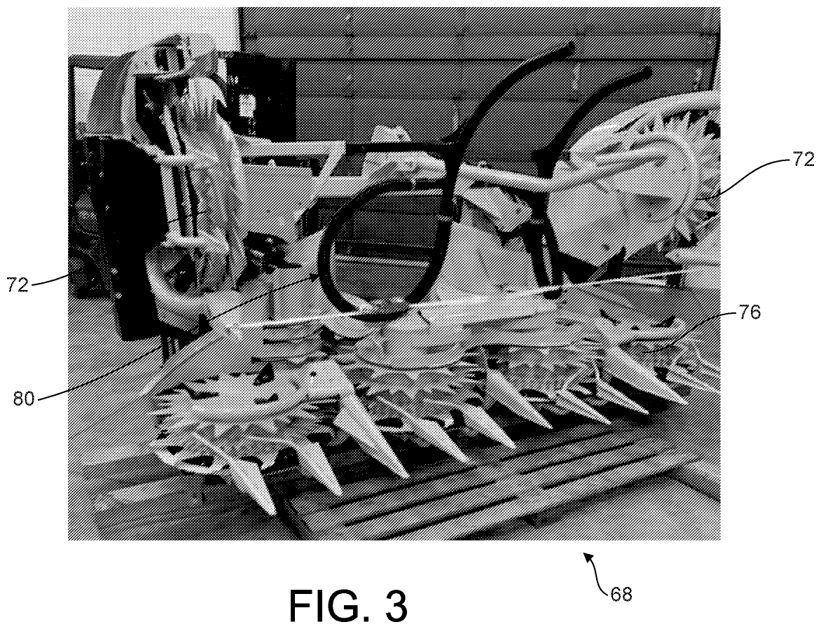

As shown in FIG. 3, a maize forage harvester header 68 provides a cut width of 15 feet (6, 30-inch rows). The maize forage harvester header 68 is built with small left and right rotating drums 72 to help feed a maize crop mat into a self-propelled forage harvester 76. Each drum 72 is equipped with sets of toothed discs that grab as it is severed merging the crop mat flow at a central header exit 80. A rotating blade is also incorporated in each drum to slice the crop at a high rate of speed. The outside header drums 72 can be folded hydraulically to support road transport.

The maize forage harvester header 68 was mounted to the baler 64 in a front frame section, replacing a typical baler pickup. The whole-plant maize harvester 62 provides an adjustable cut height to allow the maize to be severed and harvested at a stalk position 9.0 to 12.0 inches below the ear. Additionally, the whole-plant maize harvester 62 provides a swing-style hitch that allows for a six-row offset from the tractor's wheelbase. The offset provides that the maize crop is not trafficked prior to harvest.

It is also important to avoid harvested biomass from touching the ground to avoid feedstock contamination with the introduction of soil. Soil negatively impacts the conversion process to ethanol and is harder to remove than rocks or other contaminants. For this reason, the maize forage harvester header 68 is aligned directly with a baler stuffer chamber of the baler 64.

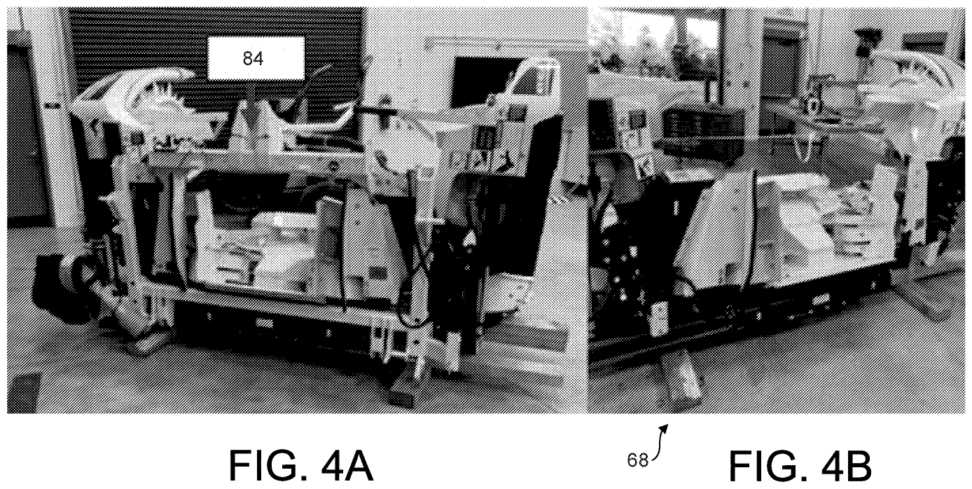

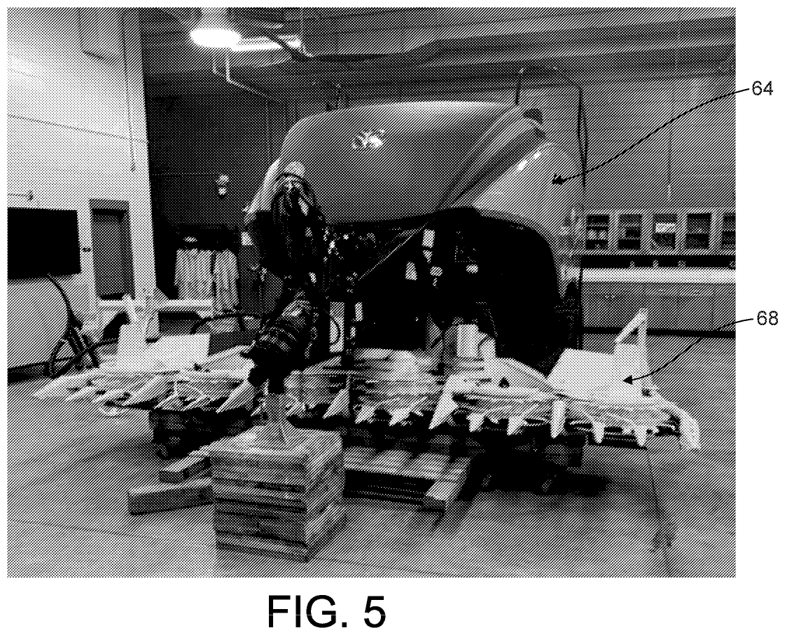

As shown in FIG. 4A, typical headers include a mounting frame 84. As shown in FIG. 4B, the maize forage harvester header 68 does not include a typical mounting frame. Elimination of the header mounting frame facilitated mounting a discharge of the maize forage harvester header 68 in close proximity to and at the same elevation as an intake throat of the baler 64.

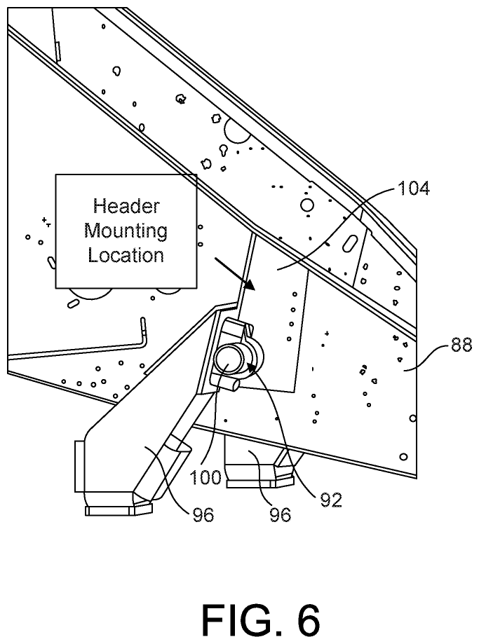

As shown in FIG. 5, the maize forage harvester header 68 is coupled to the baler 64. A typical baler pickup is eliminated so that the maize forage harvester header 68 is placed with the central header exit 80 positioned in line with the throat of the baler 64.

With the maize forage harvester header 68 in place, measurements are taken of the four, fixed mounting locations on the maize forage harvester header 68, in addition to their spatial location relative to the baler 64. The maize forage harvester header 68 is moved relative to the baler 64 as opposed to moving the baler 64 relative to the ground to account for variable plant cut height.

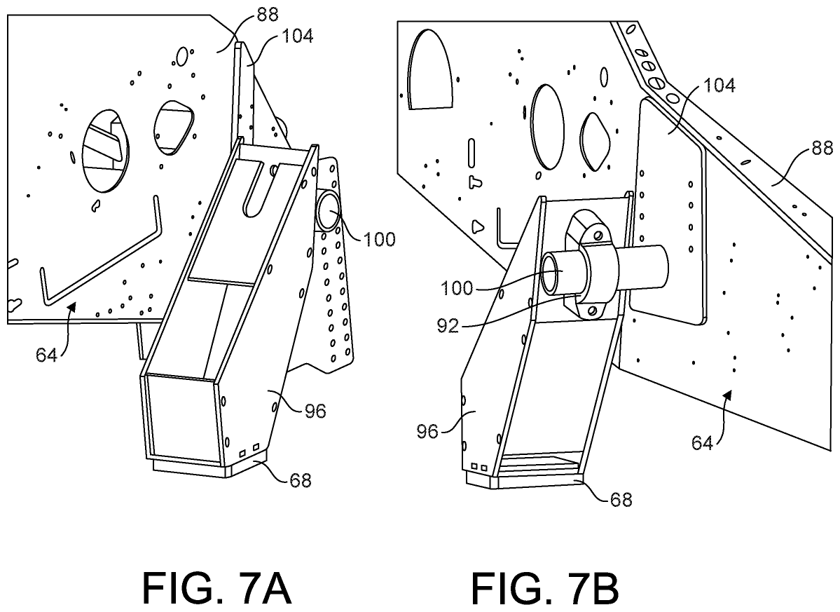

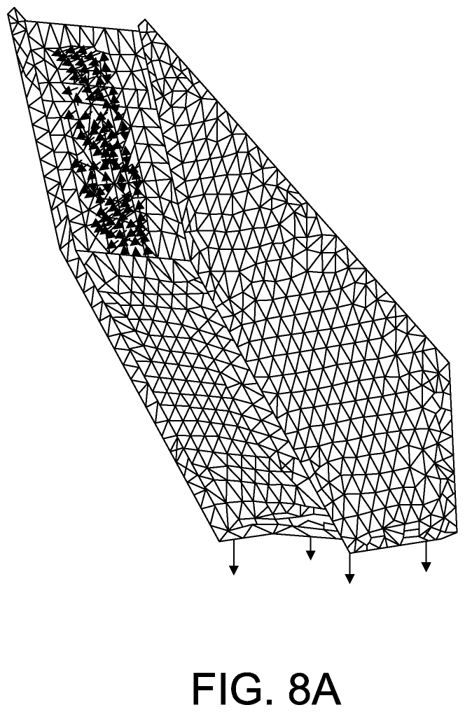

As shown in FIGS. 6, 7A, and 7B, to accomplish variable cutting height, the maize forage harvester header 68 is mounted to the baler 64 with one degree of freedom at a baler frame 88 via journal bearings 92. The journal bearing joint 92 permits rotation of the maize forage harvester header 68 about the attachment point via hydraulic cylinders attached between an undercarriage of the baler 64 and the maize forage harvester header 68. In doing so the maize forage harvester header 68 is lifted as the cylinders extend with the central header exit 80 remaining in close proximity to the baler stuffer chamber. FIG. 6 shows upper header mounts 96 that rotationally connect the maize forage harvester header 68 to the baler frame 88 of the baler 64.

As shown in FIGS. 7A and 7B, the upper header mount 96 bolts to the top of the maize forage harvester header 68 with the other end bolting to the journal bearing 92 which rotates about a rockshaft 100 attached to either side of the baler frame 88. In some implementations, the rockshaft 100 is formed by welding round mechanical tube (e.g., 4.000 in. outside diameter by 3.000 in. inside diameter) to a rockshaft plate 104 (e.g., a 0.500-inch-thick plate) which in turn is bolted to the baler frame 88.

The upper header mounts 96 include two side plates and a large lower front plate and a smaller upper front plate with bolt holes to attach the journal bearing 92 for capturing the rockshaft 100. There are also rear and bottom plates which tie the assembly together. In some implementations, all plate steel components are designed with tab and slot locators to ensure proper alignment for welding. The upper header mounts 96 includes machine steel ring stops welded to the respective rockshafts 100 to provide proper alignment and centering of the central header exit 80 with the throat to the baler stuffer chamber.

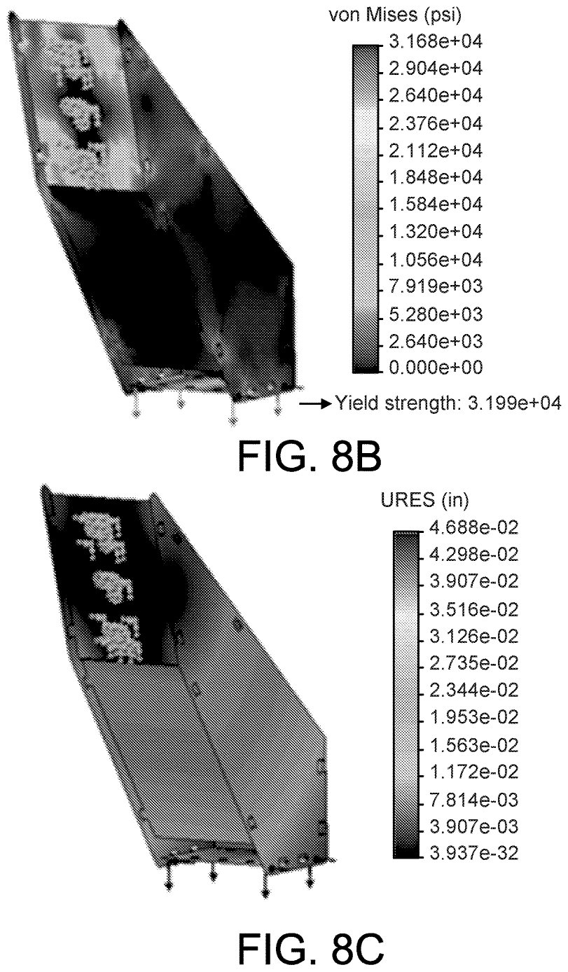

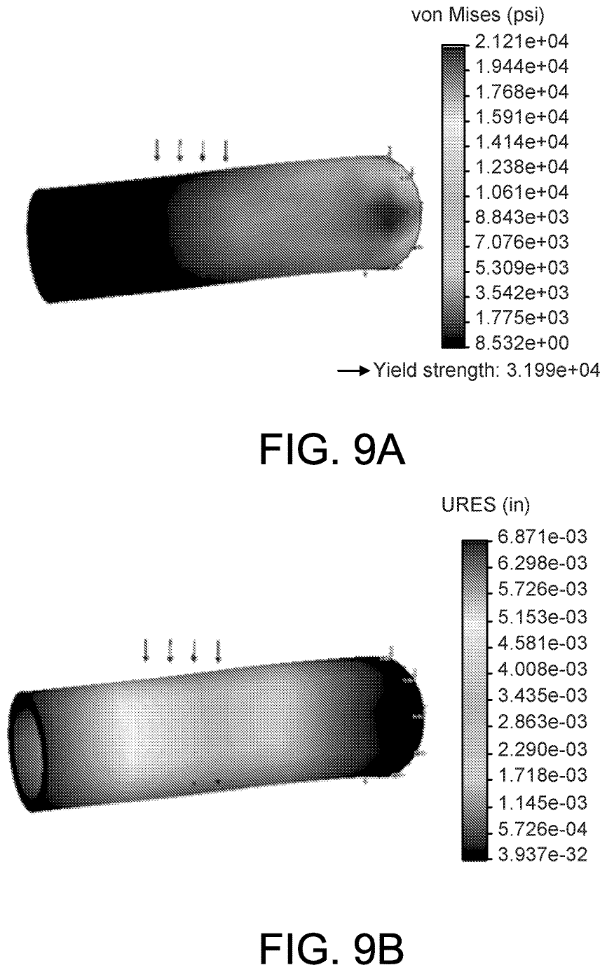

FEA results for the upper header mounts 96 are shown in FIGS. 8A-8C. Given the rotational nature of the upper header mount 96, it can be assumed that no vertical loading will be applied to lower header mounting locations as these serve to provide horizontal reaction forces and positioning adjustments via two parallel hydraulic cylinders as will be discussed below. In some implementations, a total shipping weight of the maize forage harvester header 68 is 4,850 Ibs. Elimination of the subframe reduced overall header weight to 4,350 lbs. From symmetry, and assuming static loading the reaction forces at each top mounting plate 96 should be half of the total load as is the case with a simply supported beam. A factor of safety of 2.0 was applied to the FEA loading to simulate impact loading of the header 68 at the attachment point. Additionally, a horizontal loading of 750 lbs. was applied to the base of the mount to simulate rocking of the header throughout a field. This value was an attempt to apply as factor of safety to the moment applied to the mount by the rocking of the head as this magnitude was hard to estimate. The maximum von Mises stress found in the assembly was 3.168e4 psi, under the yield strength of 3.199e4 psi. Additionally, the maximum deflection in the mount was 0.047 inches, well within an acceptable tolerance. As shown in FIGS. 9A and 9B, the rockshaft 100 was analyzed using FERA. A 4,350 lb. load was applied at the periphery of the tube 100 consistent with the projected bearing surface. The maximum von Mises stress was 2.121 e4 psi, under the yield strength of the material, while the maximum displacement was 0.007 inches which was determined to be well within the accepted margin. The FEA confirmed the upper header mounts 96 supports the anticipated loads.

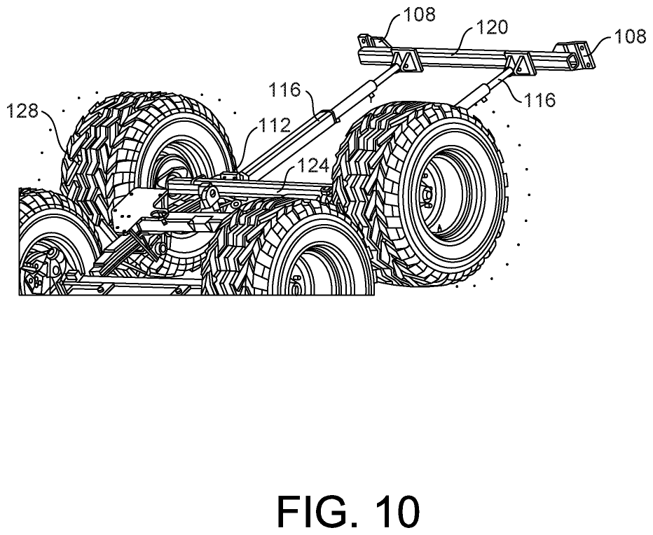

As shown in FIG. 10, lower header mounts 108 are connected to a lower portion of the maize forage harvester header 68. Lower baler mounts 112 are connected to a lower portion of the baler 64. Hydraulic cylinders 116 are connected between the lower header mounts 108 and the lower baler mounts 112 with pin connections to allow relative rotations of the hydraulic cylinders 116 to both the lower header mounts 108 and the lower baler mounts 112. The lower header mounts 108 and the lower baler mounts 112 both support the horizontal reaction force to support the maize forage harvester header 68 at the desired cut height.

The hydraulic cylinders 116 act as the primary structural members for the lower header mount 108. In some implementations, the hydraulic cylinders 116 include a bore diameter of 2.500 inches and a stroke length of 14.0 inches. Given the geometry of the maize forage harvester header 68 in relation to the cylinders 116 and cylinder attachment points 108, 112, this allows for just over 12 inches of cutting height variation in the cut-off discs for severing maize stalks below the ear. In some implementations, a square mechanical tube (e.g., 4.00-inch square with 0.500-inch wall thickness) measuring 2.75 inches in length can be used to extend the head end of the cylinder 116 (e.g., after removal and relocation of the pinned cylinder mount),

The lower header mounts 108 can be welded to the ends of a square mechanical tube 120 (e.g., 4.00 inches square with 0.500-inch wall thickness). The square mechanical tube 120 is bolted horizontally to a lower header frame. In some implementations, the lower header mounts 108 are affixed to the square mechanical tube 120 using U-bolts. Similarly, the lower baler mounts 112 are affixed to a baler front axle 124 of a baler undercarriage 128 utilizing U-bolts. In some implementations, the mounting brackets 108, 112 are fabricated from 0.500-inch-thick plate steel.

Assuming a cylinder actuation pressure of 3,000 psi, available from the tractor selective control valves to make header height adjustments, and a cylinder inside diameter of 2.500 inches, the available actuation force exceeds 10,600 lbs. combined for both cylinders 116. The center of gravity of the maize forage harvester header 68 lies closer to the pivot point of the upper mounting bearings 92 than the lower baler mounts 112 for the hydraulic cylinders 116. This ensures that there is a positive mechanical advantage available for the cylinders 116, verifying that they would have sufficient force to adjust the header height.

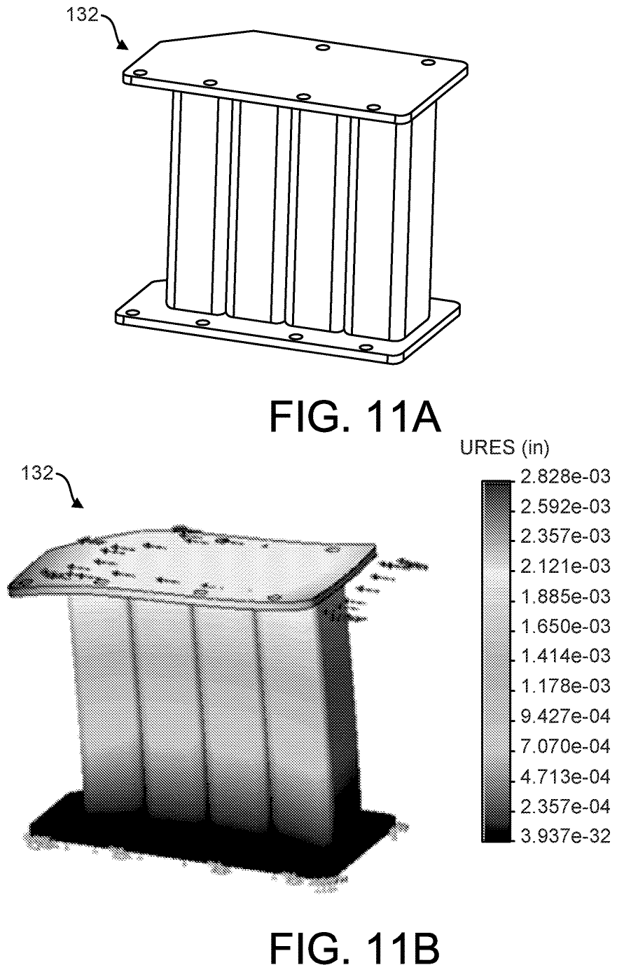

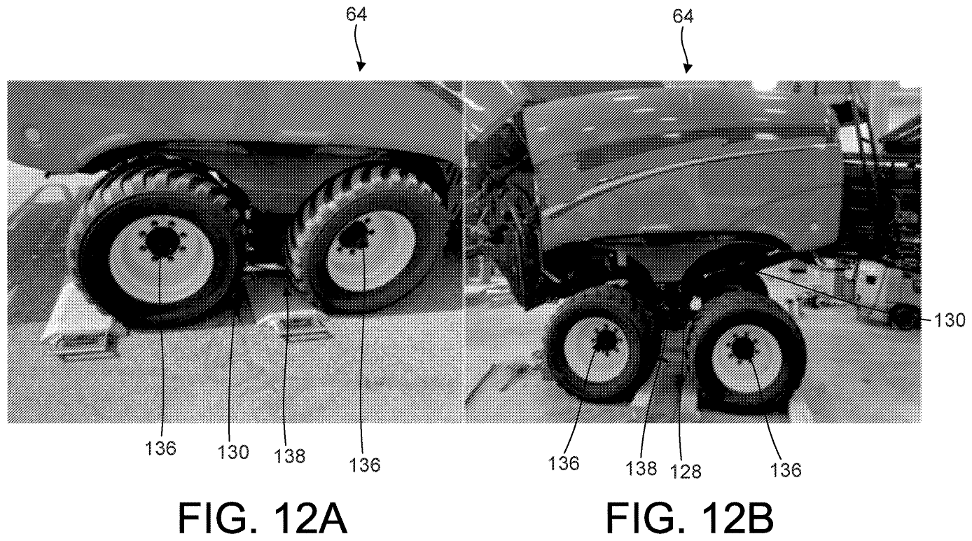

It can also be advantageous for the whole-plant maize harvester 62 to increase the vertical height of a baler frame 130 (see FIGS. 12A and 12B) in relation to the baler undercarriage 128. The spatial relation of the maize forage harvester header 68 relative to the baler frame 130 can require 24.50 inches of lift between the baler undercarriage 128 and the baler frame 130. As shown in FIGS. 11A and 11B, a vertical spacer 132 provides the necessary baler lift.

As shown in FIGS. 12A and 12B, the baler undercarriage 128 includes two axles 136 supported by the ends of inverted leaf springs 138. FIG. 12A shows the baler 64 in a traditional configuration. FIG. 12B shows the baler 64 with the leaf springs 138 pinned in the middle in a revolute joint which in turn was bolted to the baler frame 130. The increased height requirement is nearly met by rearranging the orientation of the suspension components. The axles 136 are made of 3.50-inch square mechanical tube and the thickness of the leaf spring stack 138 was also 5.50 inches. Placing the axles 136 below the leaf springs 138, instead of on top, lifted the baler 34 vertically by 7.00 inches. Additionally, the arch of the leaf spring pack 138 when combined with the stacked spring height is 16.00 inches. By flipping the leaf stack 138 with the arch directed downward as opposed to the stock upward configuration, the baler 64 is lifted an additional 16.00 inches.

In total, the baler 64 is lifted 23.00 inches by rearranging the spring 138 orientation and axle mounting locations on the baler undercarriage 128. When combining the baler lift referenced here with the pivoting header connection, the combine capabilities met the 24.50-inch baler lift criterion.

The whole-plant maize harvester 62 also includes a swing hitch 140 and connection to the baler frame 130 to support offset whole-plant harvesting of the un-trafficked maize crop. The swing hitch 140 aligns the maize forage harvester header 68 with a 6.00-inch offset from the outside of the tractor tire. Additionally, to improve functionality of the baler 64, it is desirable for the swing hitch 140 to swing to both left and right of a center transport position.

Expected loading was identified to support FEA. The horizontal draft force required to pull the baler 64 and maize forage harvester header 68 through a field was estimated using the Wismer-Luth equation for motion resistance as shown in Eq.1.

$$MR = W ( \frac{1}{Bn} + 0.04 + \frac{0.5 S}{\sqrt{Bn}} ) \qquad ( 1 )$$

In Equation 1, motion resistance (MR) and weight (W) are in units of lbs. Additionally, Bn is a dimensionless ratio referred to as the wheel numeric and s is percent slip in decimal format. Values for Bn and s were obtained from Tables 1 and 2 from ASABE D497.7 standard summarizing agricultural machinery management data.

TABLE 1

| Cone Index and Bn for Various Soil Conditions, (ASABE, 2011). | | |
|---|---|---|
| Soil | CI (kPa) | Bn |
| Hard | 1,800 | 80 |
| Firm | 1,200 | 55 |
| Tilled | 900 | 40 |
| Soft, | 450 | 20 |
| Sandy | | |

TABLE 2
Tractive Conditions for Various Soil Conditions, (ASABE, 2011).

| Tractor | Tractive Condition | | | |
|---|---|---|---|---|
| Type | Concrete | Firm | Tilled | Soft |
| 2WD | 0.87 | 0.72 | 0.67 | 0.55 |
| MFWD | 0.87 | 0.76 | 0.72 | 0.64 |
| 4WD | 0.88 | 0.77 | 0.75 | 0.70 |
| Track | 0.88 | 0.76 | 0.74 | 0.72 |

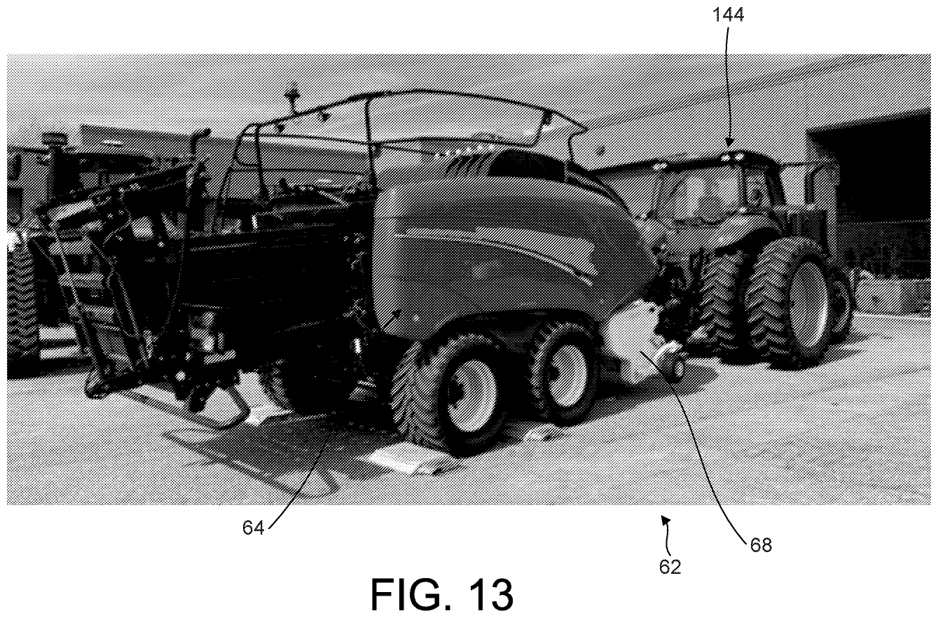

Using Table 1, the worst-case scenario for the whole-plant maize harvester 62 would be operating on tilled soil, and therefore a value of 40 was selected for Bn and a slip(s) of 0.65 was selected from Table 2. It is important to note that generally, trailing wheels do not slip, however by adding slip into the equation, an additional factor of safety is being applied to the hitch loading case. The weight of the baler 64 was obtained using pad scales (Intercomp PT300, Medina, MN) placed on a level, hard surface. The process is shown below in FIG. 13 and the results are summarized in Table 3.

TABLE 3
Baler Weight Summary.

| | Incline | |
|---|---|---|
| Tire Location | 0⁰ | 15⁰ |
| Front Left | 4,495 | 4,720 |
| Rear Left | 4,875 | 4,815 |
| Front Right | 4,705 | 4,765 |
| Rear Right | 4,740 | 4,555 |
| Jack Stand | 3,705 | 3,950 |
| Total | 22,520 | 22,805 |
| Weight | | |

* Weight in lbs.

Summing the individual transport tire weights, and adding a 5,000 lb. to account for the header and mount, the undercarriage supported weight of the baler (W) was determined to be 27,500 lbs. Given the values for W, Bn, and s, the motion resistance was calculated to be 3,200 lbs. as shown in the Eq. 2.

$$MR = 27 , 500 lb ( \frac{1}{40} + 0.04 + \frac{0.5 ( 0.65 )}{\sqrt{40}} ) = 3 , 200 lbs \qquad ( 2 )$$

The hitch weight was estimated at the tractor drawbar, which served as the reaction force in support of FEA to ensure structural rigidity and to prevent premature failure. Early on, the initial design called for the swing hitch 140 to be offset at a 45° angle to minimize the bending moment applied by the swing hitch 140. Any angle of less magnitude would require lengthening the swing hitch 140 along with and altered hitch load. It is the trade-off in hitch angle and length that affected bending moment and associated beam cross-sectional properties necessary to stay within the yield stress of mild steel.

Based on the width of the maize forage harvester header 68 and the wheelbase of the tractor 144, a 17-foot and 3-inch-long swing hitch 140 was selected. From the hitch connection pivot point to the undercarriage leaf spring mounting point on the baler 64 is 115.0 inches. The hitch 140 and baler frame 130 were modeled as a simply supported beam pinned about the leaf spring pivot point and the hitch pin on the tractor 144. This created a double pinned end beam with a total length of 322 inches. Additionally, the distance from the hitch jack stand to the leaf spring pivot point is 85.0 inches.

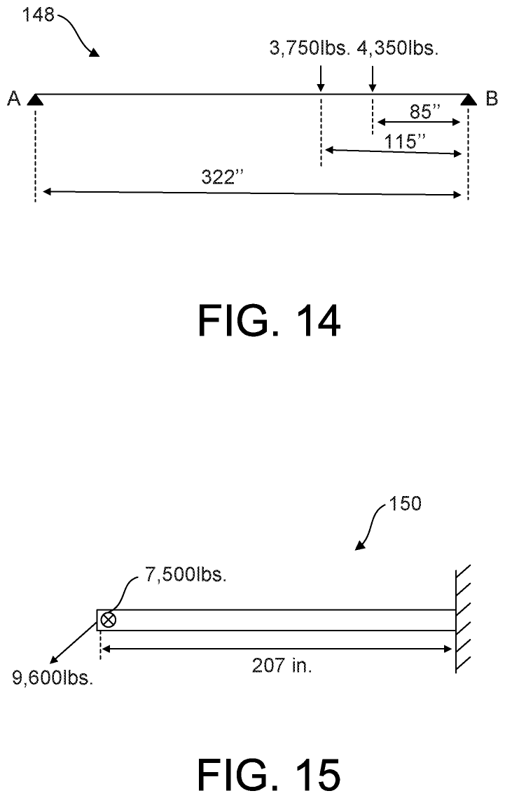

To determine the hitch weight at the drawbar it was necessary to estimate load distribution along the beam model of the baler-hitch combination. To calculate this value the jack stand weight was applied at its respective distance along the beam as determined before. The weight of the header was also added to the model beam at 85.00 inches from the leaf spring pivot point. This distance was measured with the header mock-up was placed under the baler frame. Loadings applied to the beam model 148 is summarized in shown in FIG. 14. To calculate the whole-plant harvester hitch weight, or reaction force at A, forces and moment were summed as shown in Eq. 3 and 4.

Σ_{→+}Fy=0=Ay+By−3,750lbs−4,350lbs (3)

Σ [symbol] ₊MA=0=−3,750lbs(207in)−4,350lbs(237in)+By(322in) (4)

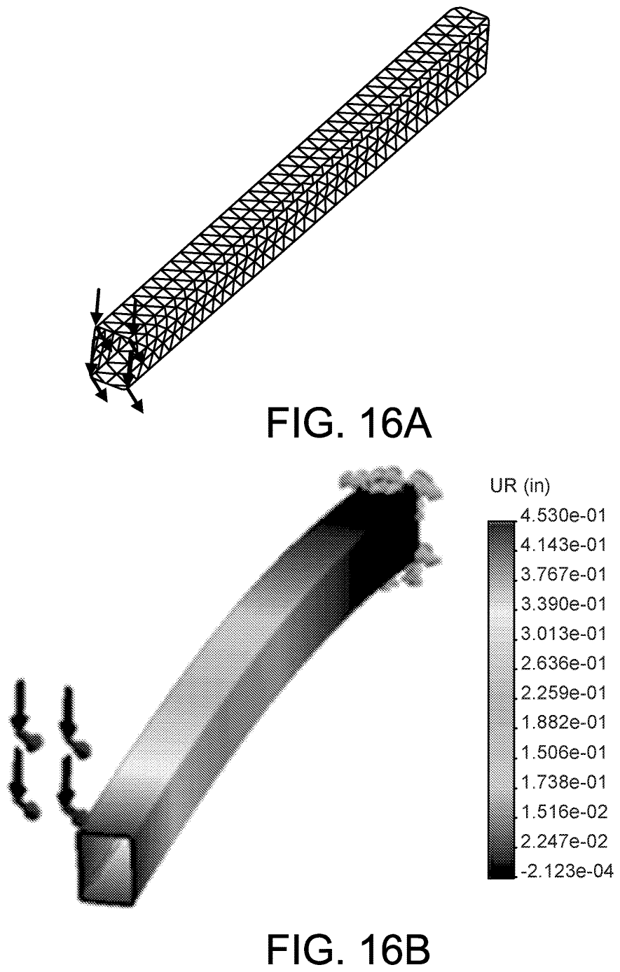

From a static analysis (Eqs. 3 and 4), the hitch vertical hitch load at the drawbar was determined to be 2,500 lbs. To ensure the structural integrity of the hitch design, a factor of safety of 3.0 to account for impact loading (7,500 lbs.). The horizontal draft force was obtained using the rolling resistance (Wismer-Luth equation) of the four wheels at the undercarriage. A factor of safety of 3.0 was also applied to the horizontal draft load (9,600 lbs) at the hitch. The hitch loading case 150 is illustrated in FIG. 15.

Multiple FEA iterations of various hitch beam cross-sections were produced to determine acceptable mechanical tube properties to meet design requirements inclusive of stress level and deflection. The latter design criteria included von Mises stresses below the yield strength of the plain carbon steel material; and a maximum deflection of less than 0.575 inches (equivalent to L/360). The L/360 deflection requirement was obtained from (Oberg, 1992).

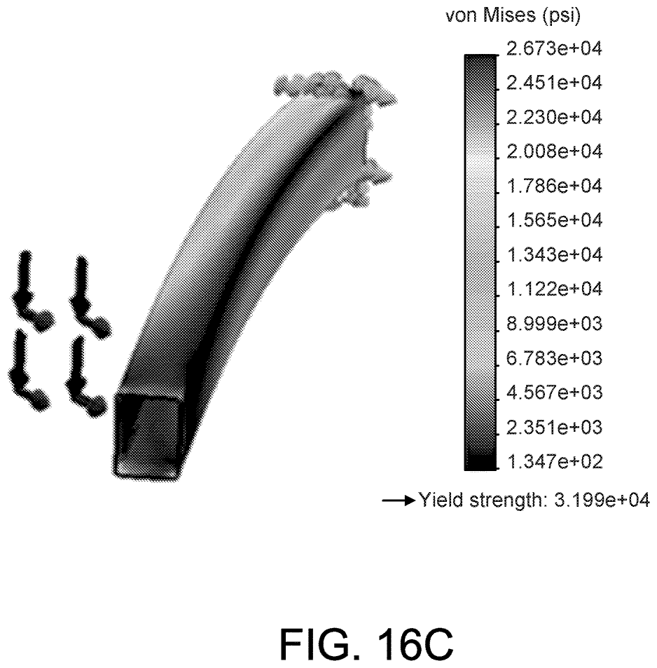

As shown in FIGS. 16A-C, the mesh and loading, deflection plots, and stress plots for the first cross section size that passed the FEA. Based on these simulations, the cross section for the hitch beam was a 16-inch by 12-inch steel rectangular mechanical tube with a 0.50-inch wall thickness. The maximum stress in this tube was 2.637e4 psi, well under the yield strength of the material. The maximum deflection also met the requirements, at 0.453 inches; less than the standard (L/360) of 0.575 inches.

The swing hitch 140 rotates horizontally about a main pin, joined together by an upper and lower plate so that the pin would be acting in double shear. This reduces the risk of bending in the main pin so that it would be able to be removed for service on the whole-plant maize harvester 62. A round tube would serve as a pin sleeve inside the hitch beam to better distribute stress to a larger area than the half inch top and bottom walls of the beam. Additionally, a third plate would be added in parallel to the upper and lower plates that sandwich the hitch beam to add structural support to the assembly.

The height of the swing hitch 140 is six feet from the ground to the bottom of the hitch beam. This allows the swing hitch 140 to pass over maize in the field without permanently bending the maize stalks to the ground or knocking cars off the stalks.

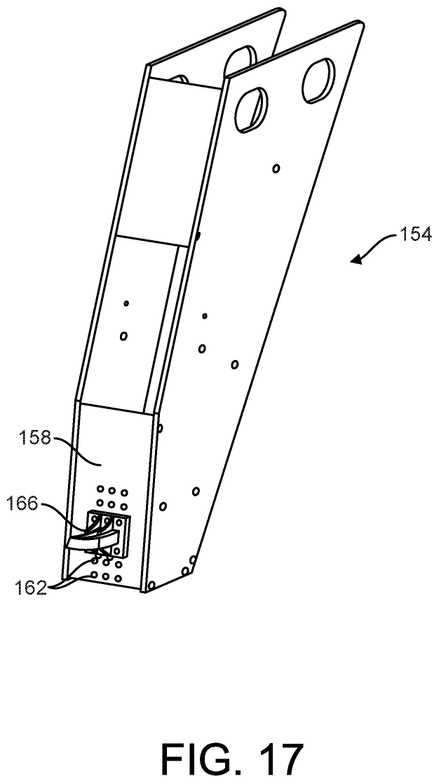

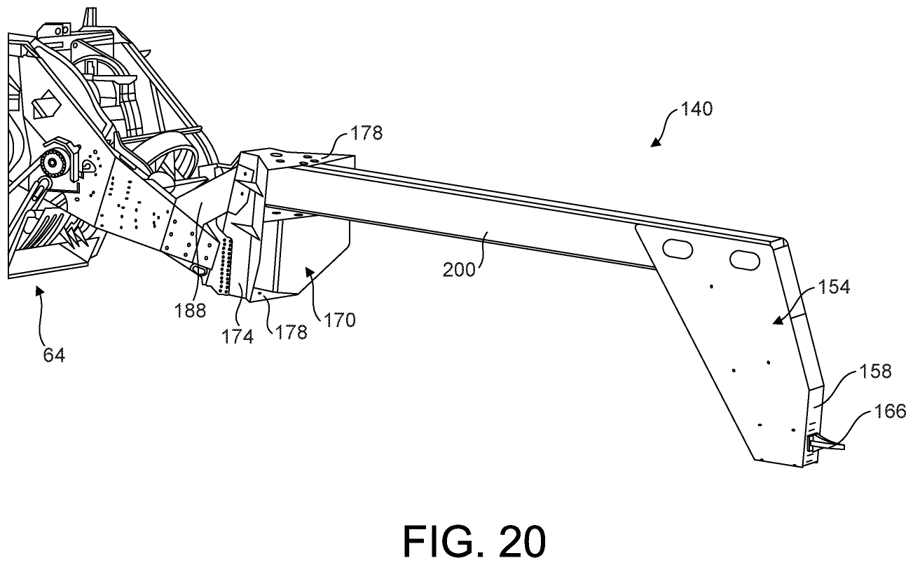

As shown in FIG. 17, a box section 154 transitions the swing hitch 140 from the high height of the main beam 200 (see FIG. 20) to the lower draw bar height of the tractor 144 which is 23 inches to the center of the hitch connection point on the baler 64. To connect the swing hitch 140 to the tractor 144, the stock bolt on pintle hitch from the baler 64 could be utilized. A front plate 158 on the tractor side of the swing hitch 140 was designed to have an adjustable tractor connection height and includes a plurality of mounting holes 162. A pintle hitch 166 assembly is bolted to this front plate 158 and the plurality of mounting holes 162 provide up to 4.5 inches of height variation in either direction vertically.

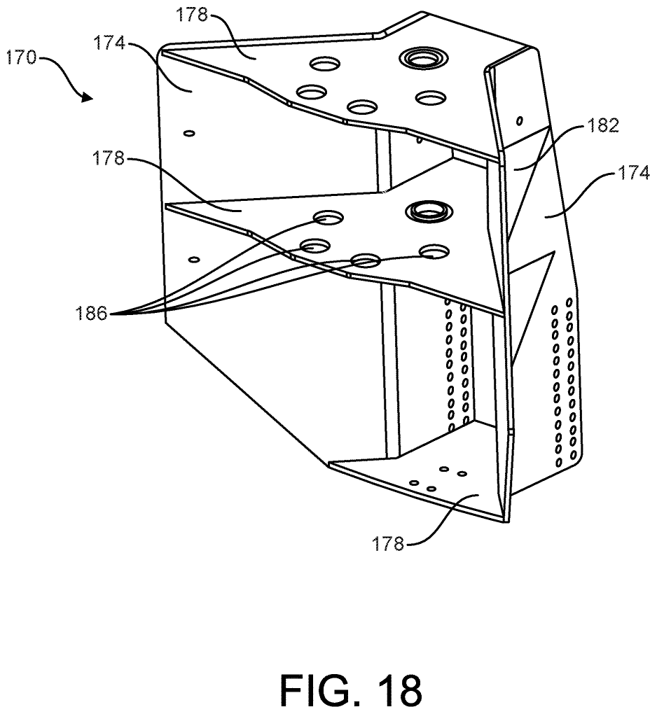

As shown in FIG. 18, a baler hitch/frame bracket 170 includes side plates 174 welded to the three horizontal plates 178 to form a pinned connection to the swing hitch 140. The two side plates 174 are structured to bolt to the baler frame 130 on the baler 64. Side plates 174 also act as a physical stop when the baler hitch is offset in either direction. Gussets 182 welded on the outside of the side plates 174 reinforce the frame bracket 170 for repositioning of the swing hitch 140. To position the swing hitch 140 in place for field operation, holes 186 for receiving keeper pins were added to the upper and lower horizontal plates 178. Positioning the swing hitch 140 to either side relative to the transport position results in a hitch angle of 45 degrees. Additional keeper pin holes can be added to secure the hitch in a transport configuration. Two extra side plates 188 (see FIG. 20) can added to merge forces applied by the swing hitch 140 to the baler frame 130. All material used to fabricate the frame bracket 170 was 0.50-inch thick ASAI 1020, low carbon steel.

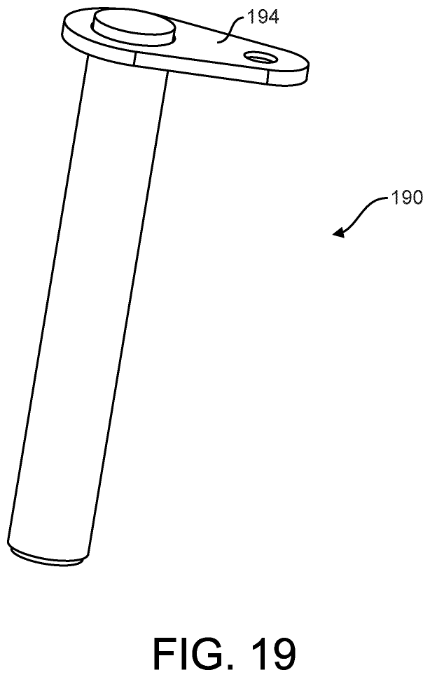

As shown in FIG. 19, a hitch retaining pin 190 is fabricated from AISI 1045, 3.00-inch diameter ground steel shaft. Pins 190 are fitted with welded steel ears 194 (0.50-inch 1020 steel plate) to secure the pin 190 in place. The pin ears 194 are formed with a 0.625-inch slot which accepted at ⅝-11 hex head cap screw fastener

As shown in FIG. 20, the swing hitch 140 includes a main beam 200 that connects the box section 154 and the frame bracket 170. In some implementations, the swing hitch 140 shown in FIG. 20 weighs over 3,000 lbs.

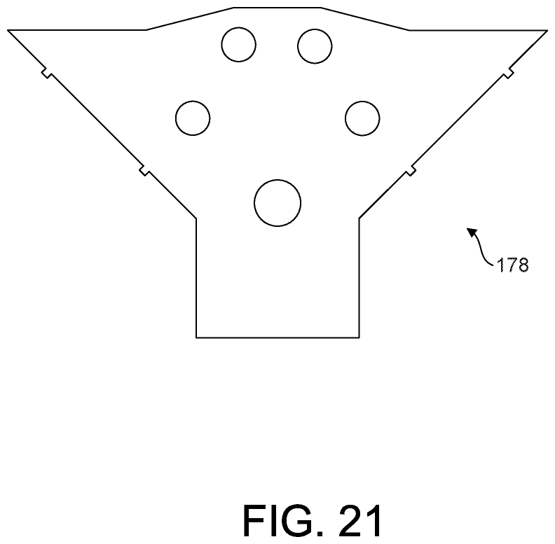

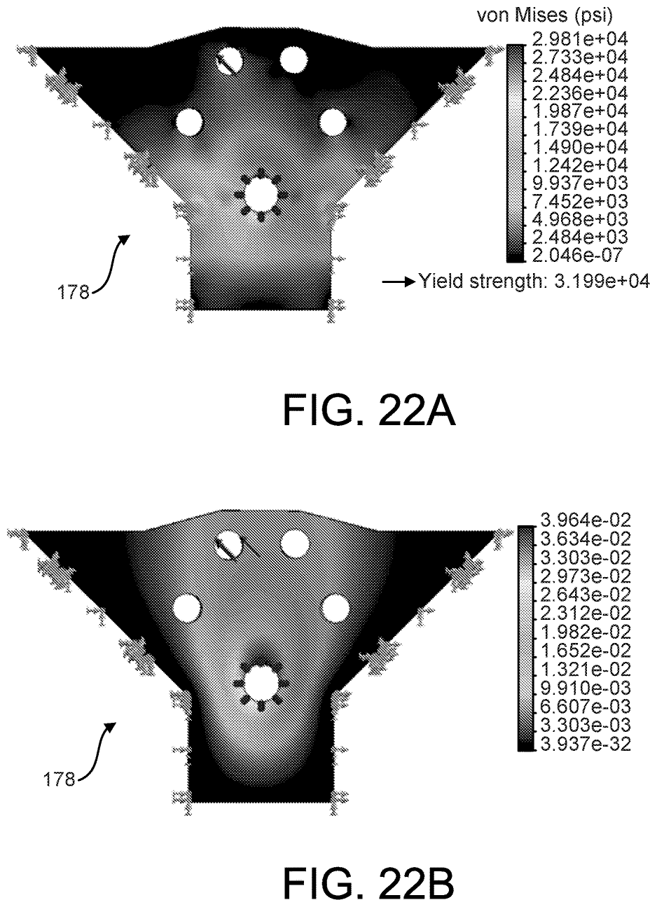

As shown in FIGS. 21-22B, the frame bracket 170 design was assessed for strength and rigidity using FEA. The middle plate 178 for the frame bracket 170 was subjected to loadings utilized to select the cross-section dimensions of the hitch mechanical tube. A 9,600 lb. load was applied in the Z-direction to the plate, normal to the swing pin axis in the middle plate for the hitch/frame connector weldment. This represented the same horizontal tractor drawbar force applied to the hitch under field conditions. Additionally, the swing hitch is pinned between an upper and lower horizontal plate, so the drawbar forces would be distributed evenly between the plates. However, for the FEA, 80% of the axial load, or 6,000 lbs. was applied to the plates at the swing pin connection holes. Internal stresses and the material deflection were estimated through FEA. The maximum von Mises stress found in this simulation was 2.981e4 psi, just under the material yield strength of 3.199e4 psi. Additionally, the maximum deflection found in the plate was 0.040 inches. Based on these results the middle hitch plate design was determined to be acceptable given the estimated loading. From the FAE performed at this stage in the design process, the preliminary hitch design was determined to be adequate at this juncture.

Traditionally, on a self-propelled forage harvester, the maize forage harvester header 68 is powered via a PTO shaft that is mechanically driven by a series of belts/pulleys and sprockets/chains. While this traditional drive seems to be the most likely approach to powering the maize forage harvester header 68, there are a few obstacles given the fitment of the maize forage harvester header 68 to the baler 64. A header drive on the baler 64 and an input shaft on the maize forage harvester header 68 can be arranged on opposite sides of the machines. Given the complexity of routing power via mechanical drive from one side of the machine to the other, a fluid drive is provided on the maize forage harvester header 68.

In some implementations, a hydraulic motor couples to the maize forage harvester header 68 and powers the header drive via a telescoping PTO shaft. The desired header speed drive was 620 rpm. The clutch torque setting was 900 N.m. The tractor 144 selected to pull and power the whole-plant maize harvester 62 had the capacity to provide up to 59.0 gpm of pressurized (e.g., 3,000 psi) hydraulic flow at the selective control valves (SCV). Hydraulic motors capable of producing 900 N.m of torque at 620 rpm required a high flow rate. In some implementations, the requirements for the hydraulic motor were based on an assumed 80% efficiency of the header, or a required torque of 720 N.m at 500 rpm.

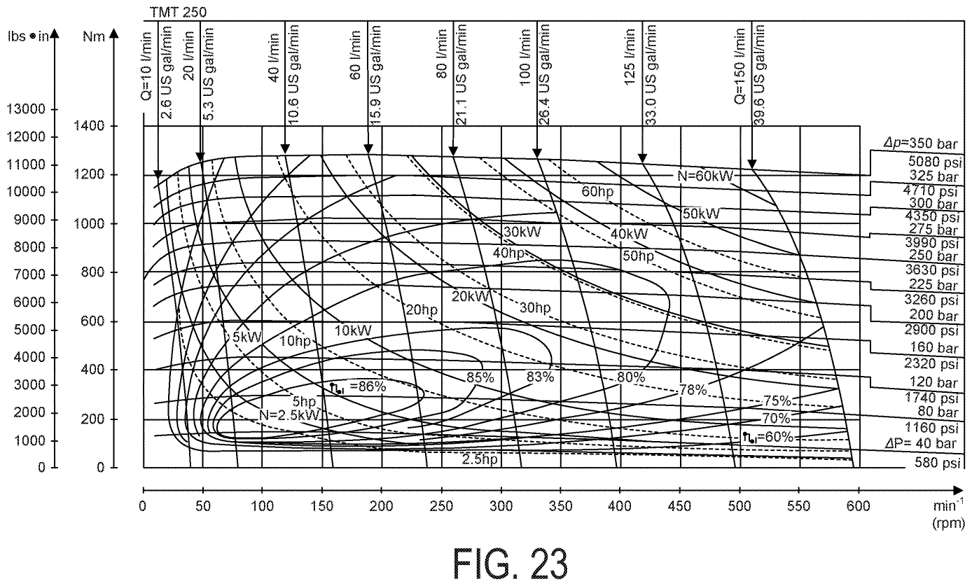

The hydraulic motor selected to power the maize forage harvester header 68 was a Danfoss TMT 250 Orbital Motor. The specification chart for this motor is given below in FIG. 23. As shown in this figure, the motor capable of producing nearly 700 N.m of torque at 470 rpm, nearly match the revised design specifications. Additionally, these motor output parameters could be achieved at an input pressure of 2,900 psi and flow rate of 33.0 gpm, both easily obtained via the SCV of the Case IH Magnum 380 tractor.

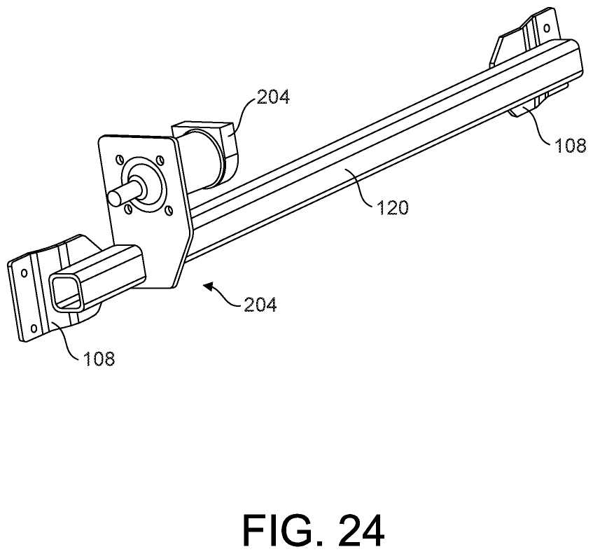

As shown in FIG. 24, a motor mount 204 supports a hydraulic motor 208 to transmit the power to the swing hitch 140. The motor mount 204 was designed to be fixed to the square mechanical tube 120 of the maize forage harvester header 68 to ensure proper transfer of power as the header cut height was adjusted. The mounting plate 204 is made from half inch steel.

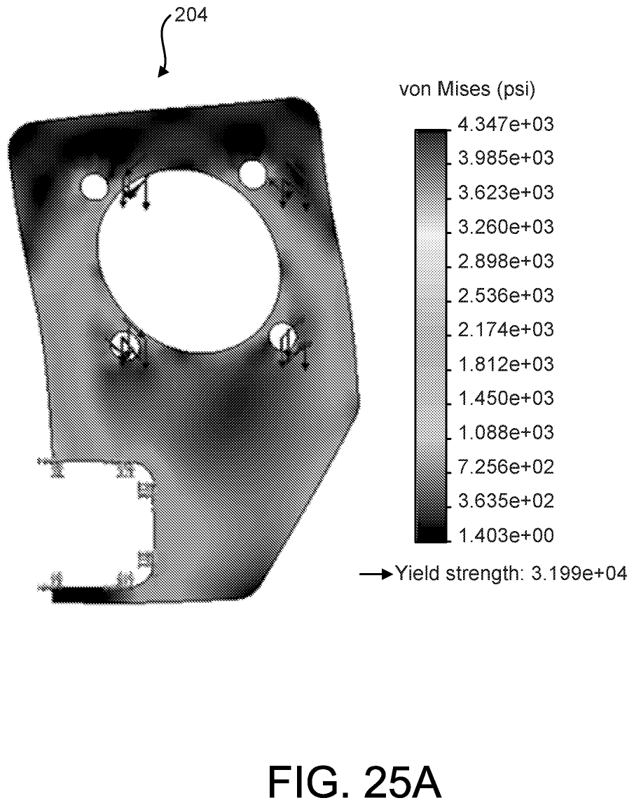

As shown in FIGS. 25A-B, a FEA was conducted for the mounting plate. Reactionary forces to counteract the 870 N.m torque were applied to the motor mounting bolt holes opposite the direction of rotation of the motor while a 400 lb. vertical force was applied at the circular plate opening that accept the motor boss. The maximum von Mises stress found in the mounting plate was 4,350 psi, while the maximum deflection was 0.002 inches. These results are well within the acceptable range, and it was concluded the revised mount design was acceptable to support the hydraulic motor and reaction torque.

To complete the header drive design, a telescoping PTO shaft is specified with 1.375-inch 21 spline yoke at the header drive connection and 1.500-inch keyed, smooth bore yoke at the hydraulic motor shaft.

APTO driveline was powers the baler 64. The driveline rotates about swing hitch vertical rotation axis in the offset position for field operation and the necessary ground clearance to clear unharvested maize crops. The driveline featured gearboxes that swivel at both end of the swing hitch to ensure swing hitch can be offset without putting the PTO shaft in a bind. A mount was designed to position the swivel gearbox concentric to the pin at the enabling rotation of the hitch at the connection to the baler frame. A second swivel gearbox was mounted at the front of the swivel hitch to provide additional clearance between PTO driveline and the ground. The output shaft of the front swivel gearbox was designed to align with the input shaft on the rear swivel gearbox with hanger bearings supporting the PTO driveline below swivel hitch rectangular mechanical tube cross-section.

The distance between these shafts was too great for standard PTO driveline components. For this reason, a solid shaft was designed to transmit power between the two gearboxes. A 1.750-inch diameter solid round bar was suspended below the swing hitch utilizing flanged bearings with eccentric locking collars. The driveshaft was then coupled to the respective gearbox using a 1.500-inch diameter keyed, smooth bore yoke on one end and a 1.375-inch, 21 spline yoke on the other end. The rear gearbox transmitted power to the baler flywheel via the original stock telescoping PTO shaft that connected the baler to the tractor. The front gearbox was then attached to a captured 1.750-inch diameter, 20 spline PTO shaft. A final telescoping PTO shaft connect the lower swivel gearbox input to the tractor. This PTO shaft was comprised of two constant velocity (CV) joints, as opposed to single cross joints, to reduce driveline speed variation and concomitant “chatter.”

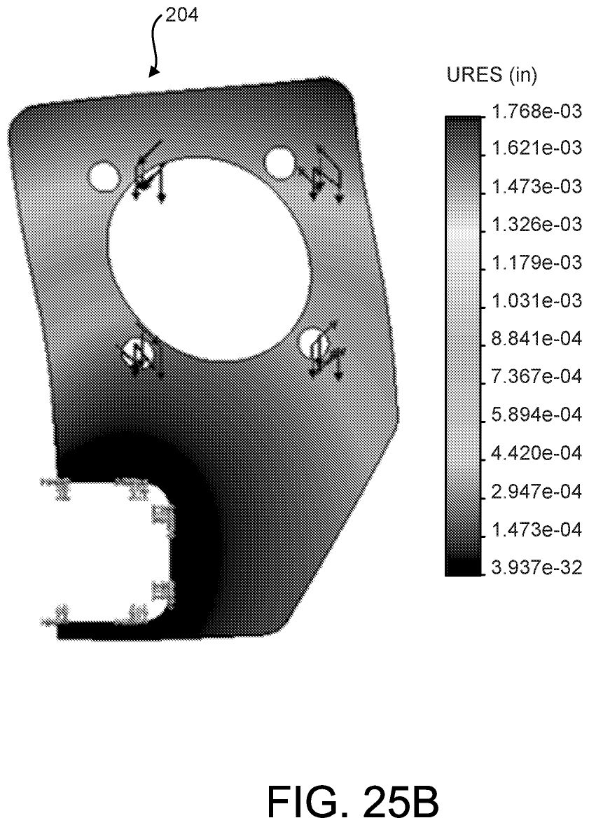

As shown in FIG. 26, a driveline 212 is shown in FIG. 26. The driveline 212 includes a tractor side swivel gearbox 216 coupled to an implement side swivel gearbox 220 by a gear drive shaft 224 and an input PTO bearing mount 228. In some implementations, the gear drive shaft 224 is supported by two hanger bearings 232.

In some implementations, all PTO shafts, yokes, and adapters selected were Series 9 rated. This rating meant these components were suitable for transferring 190 HP at 1,000 rpm, resulting in a rated torque of 1,340 N.m. This exceeded the power requirements of the baler 64. This ensured the driveline 212 would support anticipated power transmission requirements.

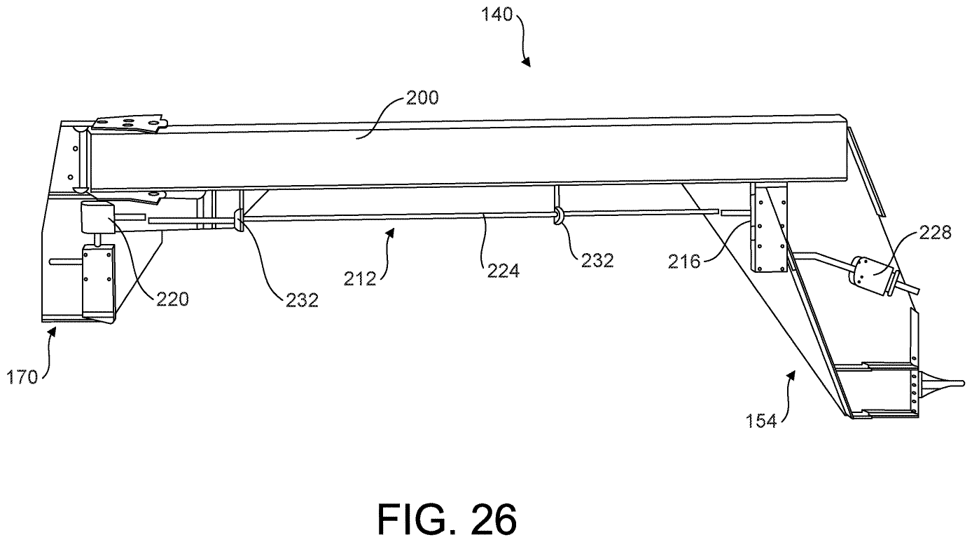

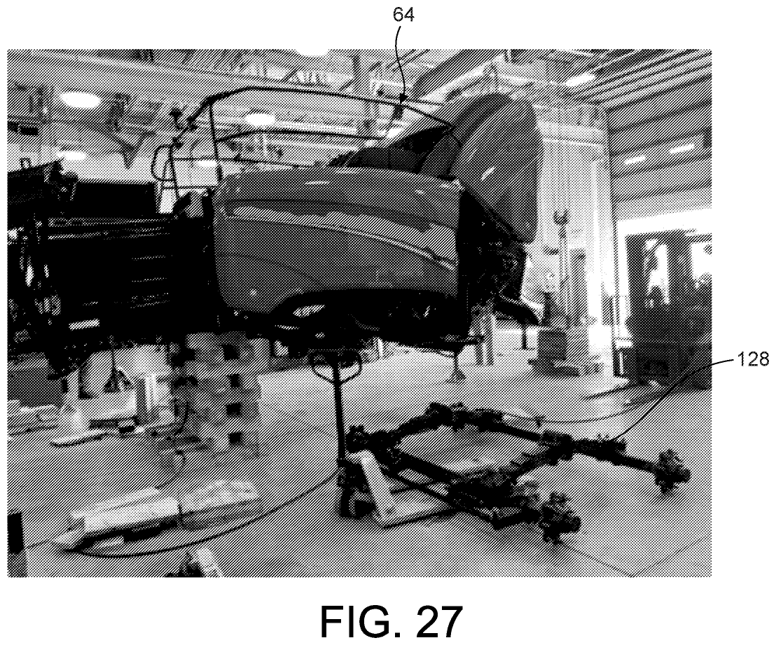

As shown in FIG. 27, the baler undercarriage 128 was removed, and the baler 64 was lifted using a combination of an overhead crane, two pneumatically actuated, hydraulic jacks and associated cribbing for safety. As shown in FIG. 28, the lifted baler 64 including the modifications discussed above provides desirable ground clearance.

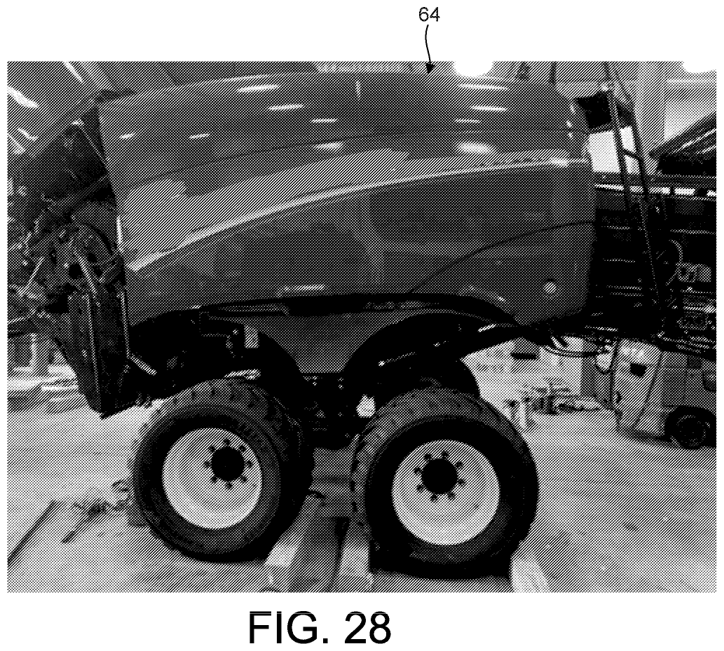

As shown in FIG. 29, the swing hitch 140 couples to the lifted baler 64.

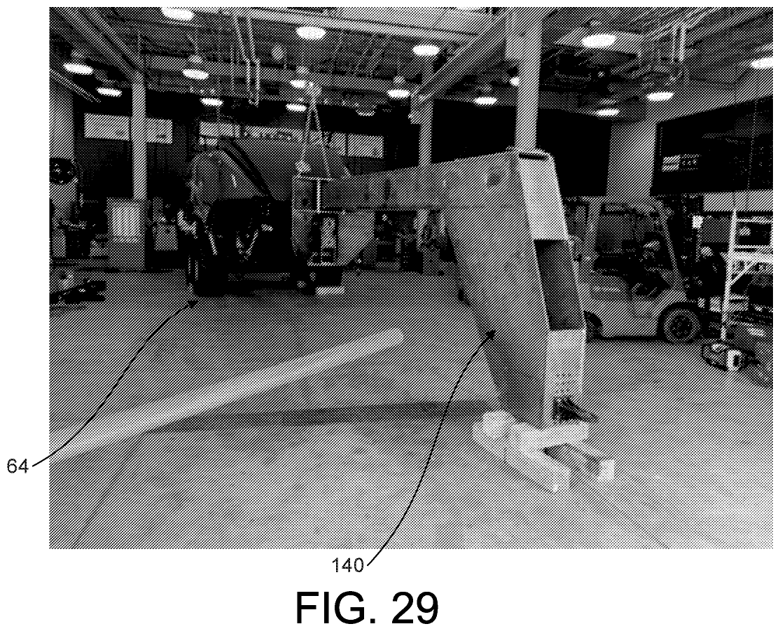

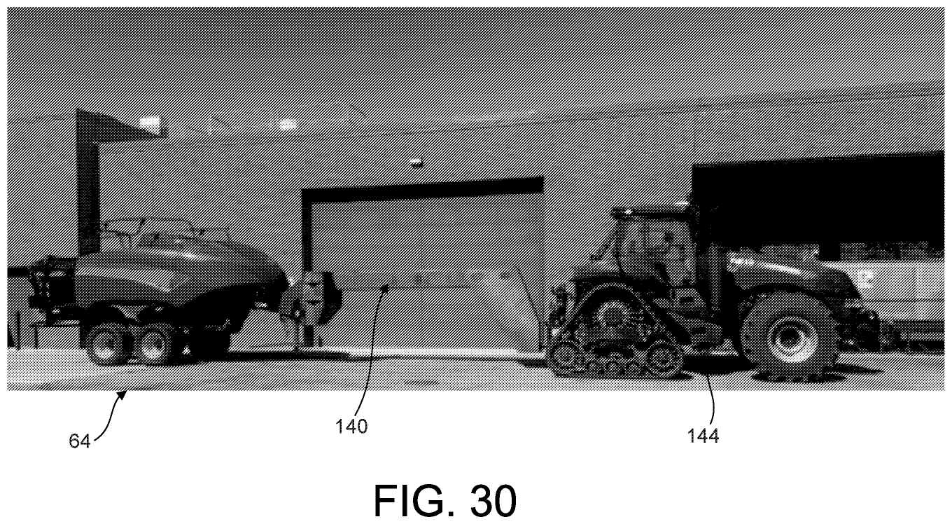

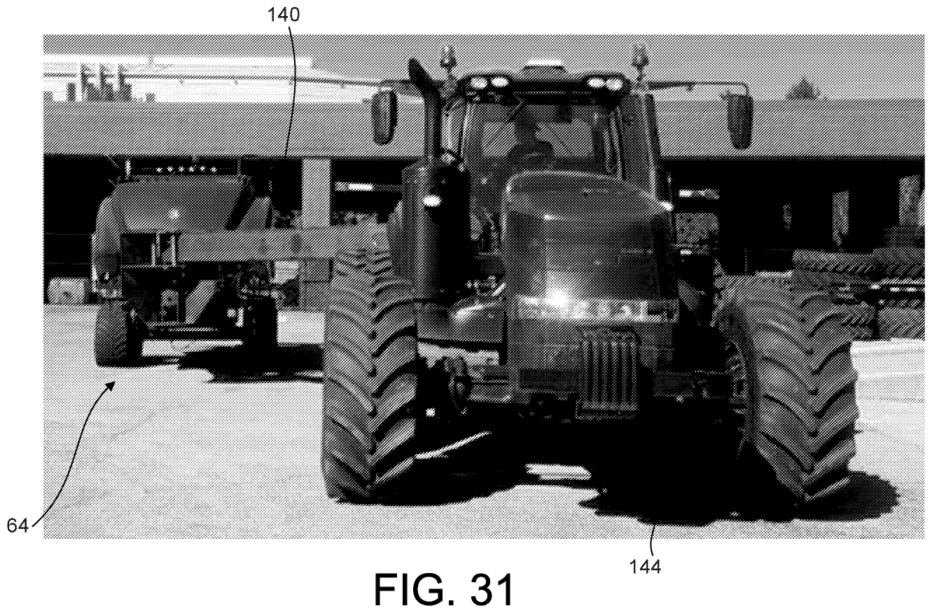

As shown in FIG. 30, the baler 64 can be pulled by the tractor 144 via the swing hitch 140 in a transport position or arrangement. As shown in FIG. 31, the baler 64 can be operated in an offset position. As shown in FIG. 32, the maize forage harvester header 68 is positioned well ahead of a throat of the baler 64.

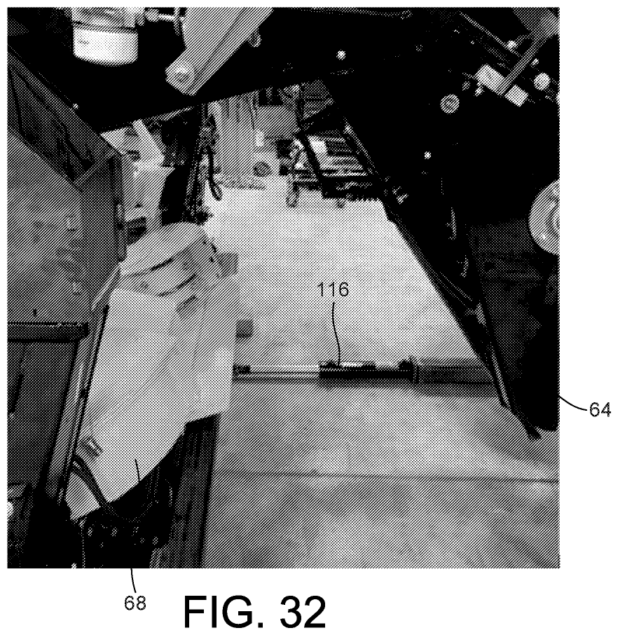

As shown in FIG. 33, in some implementations, another header mount 240 moves the maize forage harvester header 68 rearward, closing the distance between the discharge rotors on the maize forage harvester header 68 and the throat of the baler 64. The header mount 240 includes journal bearings 244 affixed to the header mount 240 and a mechanical tube shaft 248 affixed to the baler frame 130 with header height adjustments via two hydraulic cylinders 116 mounted between the undercarriage 128 and lower header frame. The lower portion of the header mount 240 is similar to the upper header mounts 96 discussed above and the length of the cylinder extension tubes are reduced to accommodate the adjusted header location.

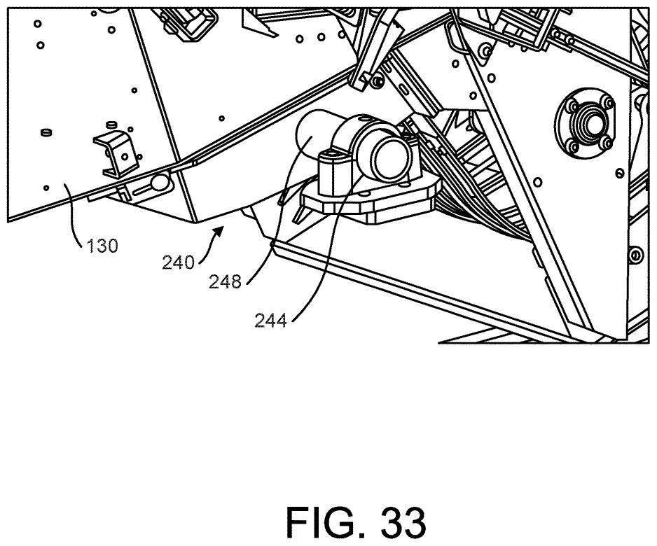

In the header mount 240 the journal bearings 244 are bolted to flat plates that bolted directly to the upper portion of the maize forage harvester header 68. In turn, these bearings 244 seat on a fixed 4.00-inch diameter steel tube with 0.500-inch wall thickness. This tube is welded to two weldments that bolted to the underside of the baler frame. The header mount 240 weldment is shown in FIG. 34. This design reduced moments applied the initial mount given shortened member lengths.

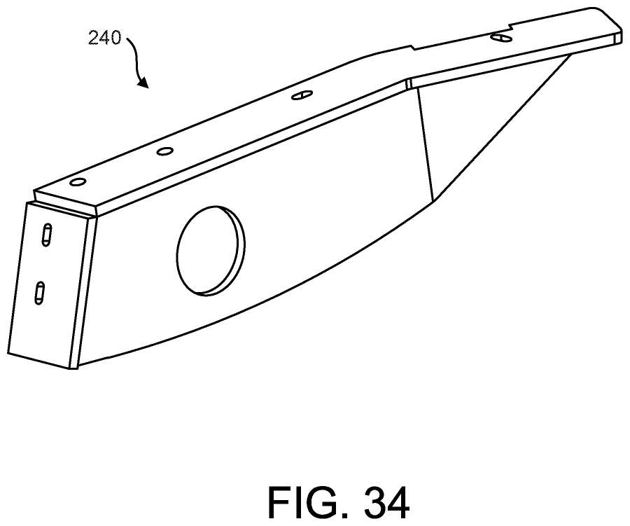

As shown in FIGS. 35A-B, FEA was conducted on the header mount 240. In this simulation, a 4,000 lb. load was applied to the fixed round mechanical tube in place of the journal bearings and in the vertical, downward direction. This simulated the full weight of the header being supported by one side of the round bar at ounce. An additional 1,000 lb. side loading was applied along this face as well to simulate any rocking of the header throughout the field. The maximum von Mises stress in this weldment was 15,800 psi, well under the yield strength of plain carbon steel at 32,000 psi. In addition, the maximum deflection determined from the FEAs was 0.014 inches, well within the range of allowable deflections.

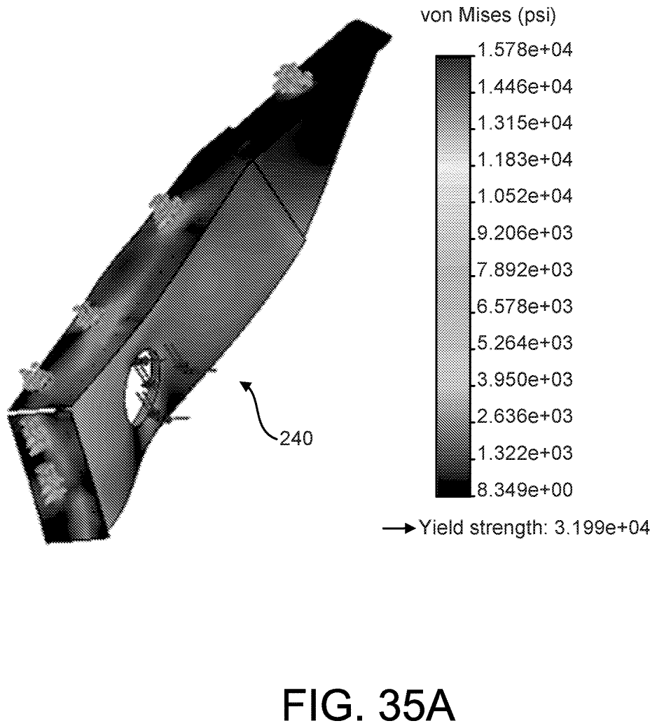

As shown in FIG. 36, to guard against damage to the baler frame 130 given the rather extensive modifications required for whole plant maize harvest (i.e., swing hitch and forage harvester head mounting locations), a superstructure 252 was designed to strengthen the baler frame 130 and swing hitch 140 connection. This assembly was fabricated from 4.00-inch square mechanical tube with a wall thickness of 0.372 inches. This assembly bolted to the frame bracket 170 and was tied to the upper baler frame 130 via the lift rings using 2.500-inch diameter round stock. In addition, struts at midspan of the superstructure bolted to the top of the baler frame 130.

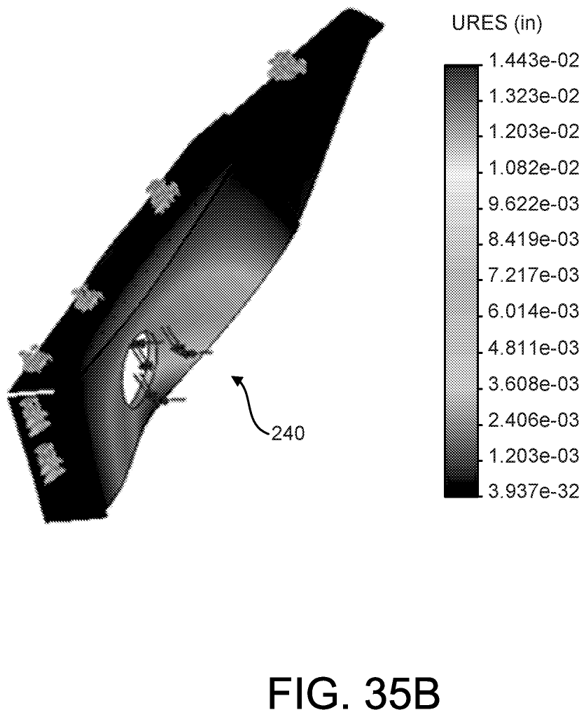

As shown in FIG. 37, when placing the baler 64 in an offset configuration, whole-plant maize harvester 62 has a tendency to list to the centerline of the tractor 144 (e.g., to the right as viewed in FIG. 37). To develop a better appreciation for weight transfer with the offset hitch configuration, the baler was placed on pad scales on a level surface. The first set of measurements occurred with the pressure in all of the tires set at 35 psi; the data are summarized in Table 4. As previously mentioned, the cutting height variation for this configuration was 11.38 inches. The next set of measurements were taken with the right-side tire inflated to 50 psi to better align with tire manufacturer load/inflation pressure tables, while the inside tires were left at 35 psi. Scale data for this configuration are summarized in Table 5. The cut height differential across the header width improved slight to 9.81 inches.

TABLE 4
Baler Individual Wheel Loads for the Offset Baler Configuration
with Uniform Tire Pressures

| Weight Location | Tire Pressure (psi) | Weight (lbs.) |
|---|---|---|
| Front Right | 35 | 9,215 |
| Rear Right | 35 | 8,670 |
| Rear Left | 35 | 2,225 |
| Front Left | 35 | 2,665 |
| Tongue Weight | N/A | 4,985 |

| | |
|---|---|
| Cutting Height Difference (in): | 11.375 |

TABLE 5
Baler Individual Wheel Loads for the Offset Baler Configuration
with Non-Uniform Tire Pressures

| Weight Location | Tire Pressure (psi) | Weight (lbs.) |
|---|---|---|
| Front Right | 50 | 9,325 |
| Rear Right | 50 | 8,485 |
| Rear Left | 35 | 2,405 |
| Front Left | 35 | 2,525 |
| Tongue Weight | N/A | 5,020 |

| | |
|---|---|
| Cutting Height Difference (in): | 9.813 |

The data presented in Tables 4 and 5 confirm the magnitude of weight transfer occurring when the baler was placed in the offset configuration for field harvest. Table 4 shows a difference of 12,995 lbs. between the right and left undercarriage wheels, while Table 5 presents a differential of 12,880 lbs. A portion of the cut height differential across the header between tire inflation pressures was likely the results of reduced tire deflection with higher inflation pressures.

Based on the data from these tables, it was decided that the baler performance would suffer if operated at full offset (i.e., 15.00 ft width). It was concluded that additional undercarriage modifications were warranted to account for weight transfer associated with the offset hitch. In response to the weight transfer concern, it was determined that field tests would be conducted with the harvester configured for a three row, or 7.50 feet, offset. For the partial offset, the header cut height variation was less than 2.0 inches. While this solution was not ideal, operation in this configuration would verify material flow between the header and the baler stuffer chamber throat. In addition, field operation of the harvester during 2020 cropping season would provide valuable insights into achievable, whole crop maize bale densities.

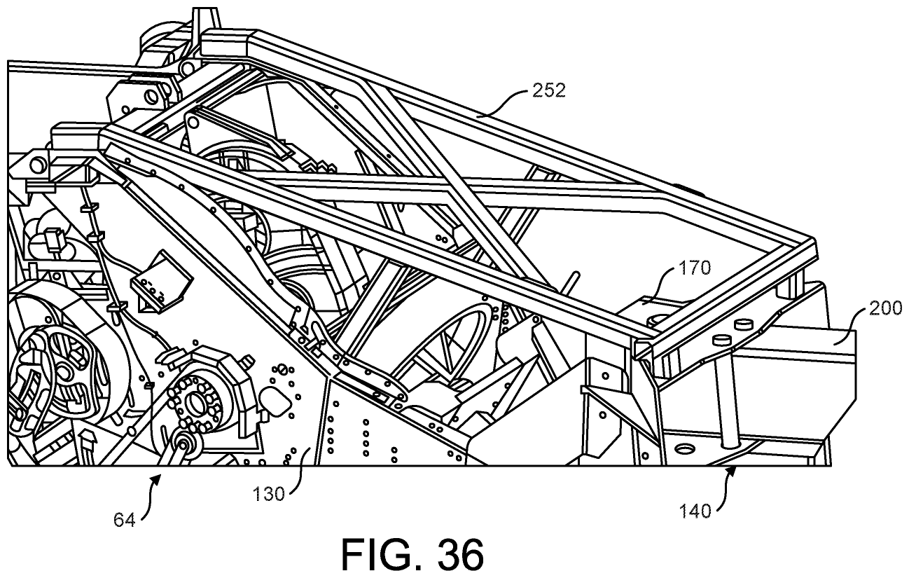

As shown in FIG. 38, the whole-plant maize harvester 62 is installed on the tractor 144 by bolting the hydraulic motor 208 in place and running hydraulic lines between the motor 208 and SCVs at the rear of the tractor 144. After a brief break-in period, the header 68 was brought up to full operating speed. Full speed operation induced minimal vibration to the whole-plant maize harvester 62.

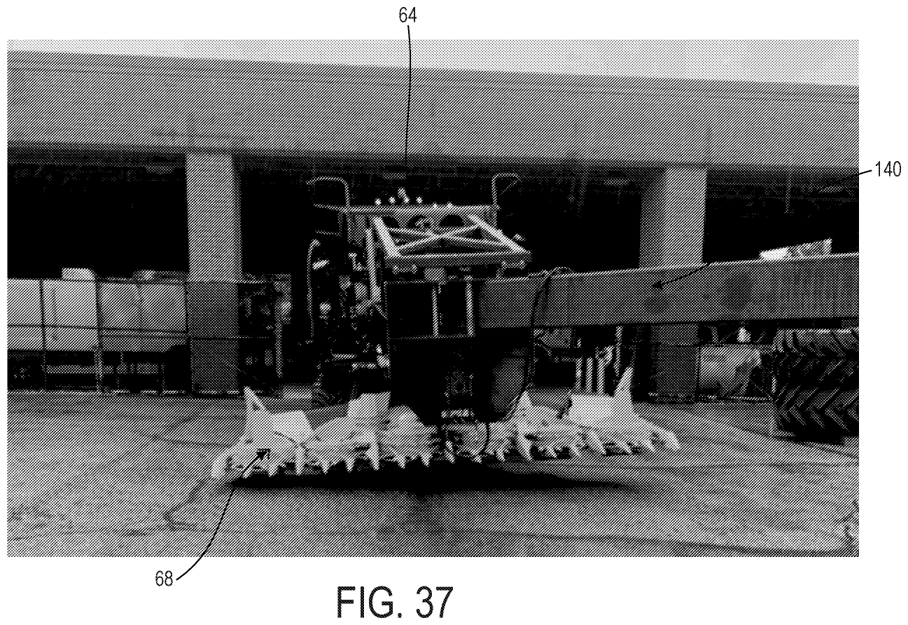

Once fabrication and assembly of a prototype were completed, the whole-plant maize harvester 62 was initially field tested. The goal for initial field testing was verification of the whole plant harvester's ability to sever the maize crop, feed it to the baler stuffer chamber, and then form high density bales. As shown in FIG. 39, the initial field test proved successful confirming the header ability to gather, sever and uniformly feed the maize crop to the throat of the baler stuffer chamber to avoid plugging.

Once it was confirmed that material flow from the header top the balers was acceptable, the ground speed was increased up to 6.5 mph to assess higher mass flow rates of material from the header to the bale chamber. The baler monitor indicated moderate loading of the bale chamber with significant reserve capacity to be realized. Harvester ground speed was gradually increased during testing as the operator gained confidence with the various machine operating parameters and functionality. The baler 64 produced twelve bales of varying dimensions and weights. Based on the success of the initial field testing, the prospects of whole plant maize harvesting, and baling appeared to be well within reach.

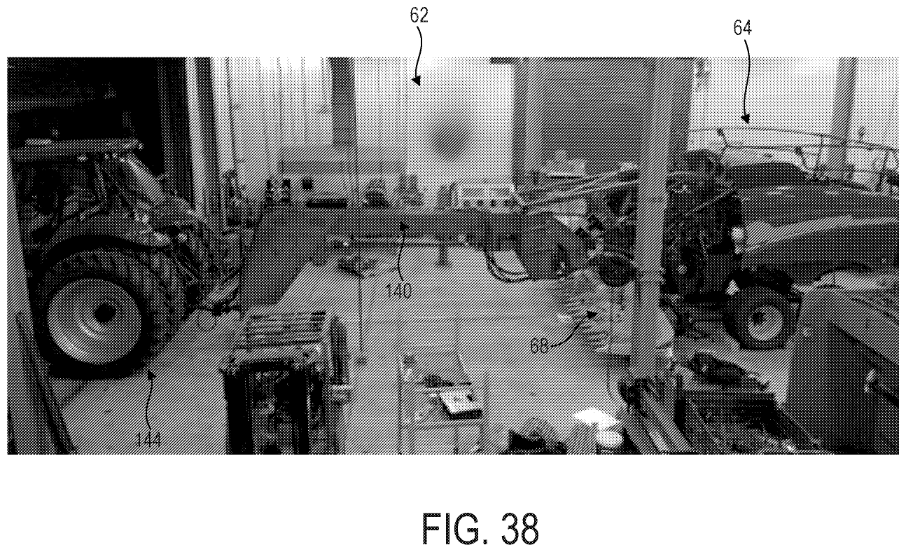

The whole-plant maize harvester 62 was subjected to more extended field testing. The whole-plant maize harvester 62 was attached to the tractor 144 and driven to a field 254 illustrated in FIG. 40. The field 254 was broken up into four blocks that contained three treatments each. The first treatment (T1) was comprised of traditional corn grain harvest with a John Deere combine while leaving all of the stover in the field. The second treatment (T2) collected all of the grain with a combine as in T1, however the stalks and remaining stover were later chopped down with a mover conditioner and baled. This process represented how typical multi-pass approaches collect both corn grain and stover. Finally, in treatment three (T3) the whole-plant corn harvester was used to harvest and bale both the corn grain and stover simultaneously.

As shown in FIG. 40, each treatment was comprised of 24 rows with a length of 900 feet each. Therefore, each treatment was composed of approximately 0.496 acres. Each treatment of the blocks was planted with the same maize hybrid, same population, and same row spacing. In addition, the field was relatively flat, with little elevation relief. This report will only discuss and evaluate the performance of the whole-plant harvester for each of the harvested blocks in T3. The other two treatments, T1 and T2, are outside the scope of this project.

The baler 62 was offset three rows (7.50 feet) as discussed above, enabling the simultaneous harvesting of three maize rows. As a result, eight passes were required to harvest all 24 rows within each treatment block to be harvested. Some of the bales were to be wrapped where the maximum bale length could not exceed 6.0 feet. To ensure that the bales would not be inadvertently oversized, bale length was set to 5.50 feet through the ISOBUS virtual terminal.

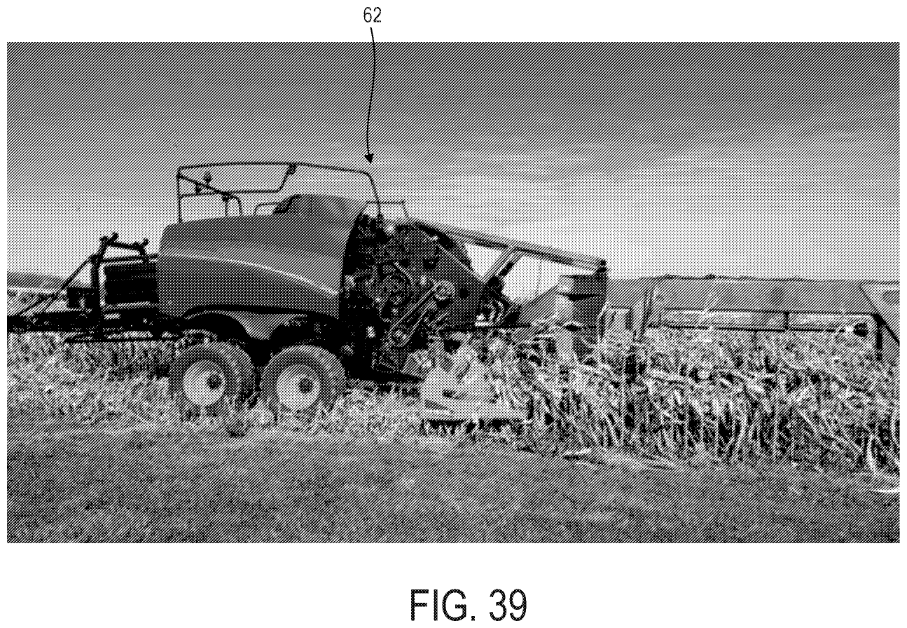

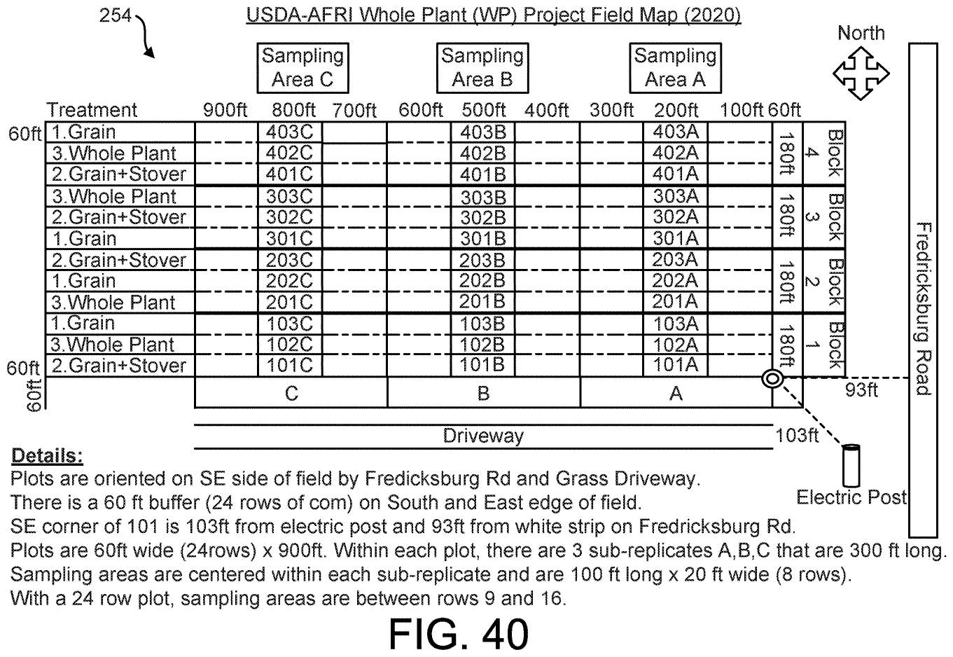

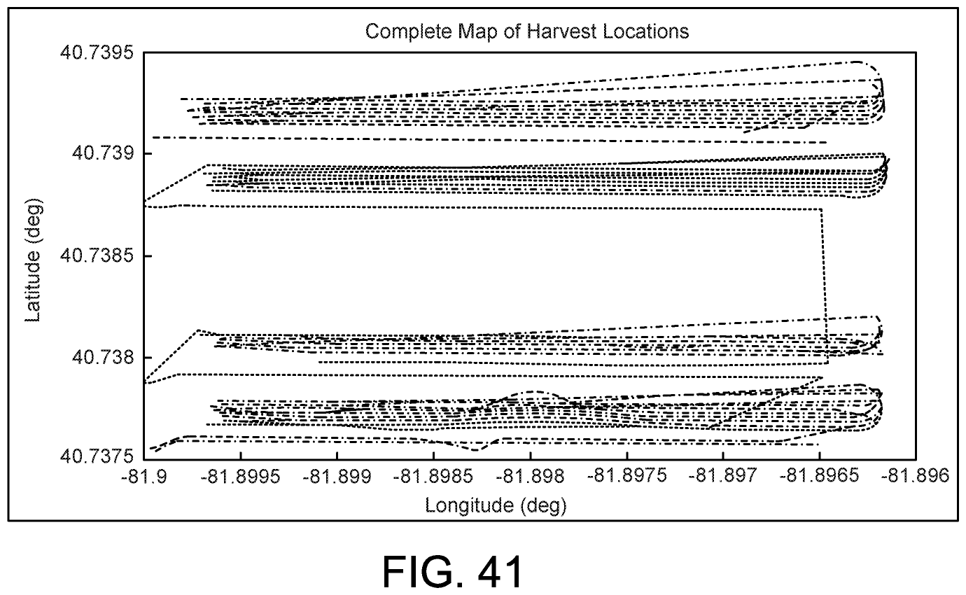

A map of the tractor path throughout the field is illustrated in FIG. 41. These GNSS data were filtered for only those points when the PTO was engaged, and the baler was operating. Additionally, FIG. 42 shows the breakdown of the tractor paths within each individual block, filtering out travel between blocks. This figure also shows the location of where each bale was dropped within its respective block. FIG. 43 shows the maize crop conditions at harvest, as well as the bale distribution throughout the field 254.

At the time of harvest, controller area network (CAN) data was not available from the baler 64 electronic control unit (ECU), therefore bale data regarding the bales' physical metrics had to be recorded by hand. Dimensional and mass data for various bales was recorded and calculated the density from these values. However, for logistics reasons, not all bales were measured. Additionally, “block” integrity was not preserved, therefore there was not an equal distribution of bales utilized across the four blocks. All bale data were summarized in Table 11.

As shown in Table 6, lengths of the bales varied from 5.1 to 5.6 ft., with a mean of 5.3 ft. The width of the bales did not differ significantly, at an average of 4.0 ft. The height of the bales had slightly more deviation, ranging from 2.8 to 3.0 ft., averaging 2.9 ft. in height. The weight of the bales deviated in magnitude with a minimum weight of 1,263 lbs, and maximum of 1,397 lbs. The standard deviation of the mass of the bales however was only 30.9 lbs, which is 2.3% of the mean. The density of the bales had a mean of 21.5 lbs/ft, but ranged from 19.7 to 23.0 lbs/ft.

Each block produced 12 bales, with the exception of block 3, which produced 11 bales. Given that the average weight of each bale was 1,263 lbs, nominally each block produced around 15,000 lbs of biomass comprised of maize grain and stover. Using the previously mentioned block area of 0.496 ac, the machine harvested at a rate of 15.1 ton/ac. Utilizing the standard deviation of the bale data, harvest rates likely ranged from 14.8 ton/ac to 15.4 ton/ac.

TABLE 6
Bale Data Recorded from 2020 Field Trials.

| Bale | | | Height | Weight | Density |
|---|---|---|---|---|---|
| Number | Length (ft) | Width (ft) | (ft) | (lbs) | (lb/ft\hat{ }3) |
| 3 | 5.2 | 4.1 | 3.0 | 1360 | 21.1 |
| 5 | 5.3 | 4.0 | 2.9 | 1301 | 20.9 |
| 7 | 5.3 | 4.0 | 2.8 | 1334 | 22.4 |
| 9 | 5.4 | 4.0 | 2.9 | 1318 | 21.1 |
| 10 | 5.5 | 4.0 | 2.9 | 1331 | 20.6 |
| 11 | 5.3 | 4.0 | 3.0 | 1331 | 21.2 |
| 13 | 5.4 | 4.0 | 3.0 | 1359 | 20.6 |
| 14 | 5.5 | 4.0 | 3.0 | 1397 | 21.1 |
| 15 | 5.3 | 4.0 | 2.8 | 1330 | 22.3 |
| 16 | 5.4 | 4.0 | 3.0 | 1354 | 21.0 |
| 17 | 5.3 | 4.0 | 2.9 | 1321 | 21.7 |
| 18 | 5.4 | 4.1 | 3.0 | 1364 | 20.9 |
| 20 | 5.5 | 4.0 | 2.9 | 1365 | 21.8 |
| 21 | 5.6 | 4.0 | 2.9 | 1365 | 21.4 |
| 24 | 5.1 | 4.0 | 2.8 | 1326 | 23.0 |
| 26 | 5.4 | 4.1 | 2.9 | 1379 | 21.2 |
| 27 | 5.3 | 4.0 | 2.8 | 1319 | 21.9 |
| 29 | 5.2 | 4.0 | 2.9 | 1290 | 21.6 |
| 30 | 5.3 | 4.0 | 2.9 | 1366 | 22.6 |
| 31 | 5.4 | 4.0 | 2.8 | 1330 | 21.7 |
| 33 | 5.3 | 4.0 | 2.9 | 1371 | 22.3 |
| 34 | 5.4 | 4.0 | 2.8 | 1307 | 21.5 |
| 36 | 5.3 | 4.0 | 3.0 | 1263 | 19.7 |
| Average | 5.3 | 4.0 | 2.9 | 1338 | 21.5 |
| Std. Dev. | 0.1 | 0.0 | 0.1 | 30.9 | 0.7 |
| C.V. | 2.1 | 0.8 | 2.2 | 2.3 | 3.4 |

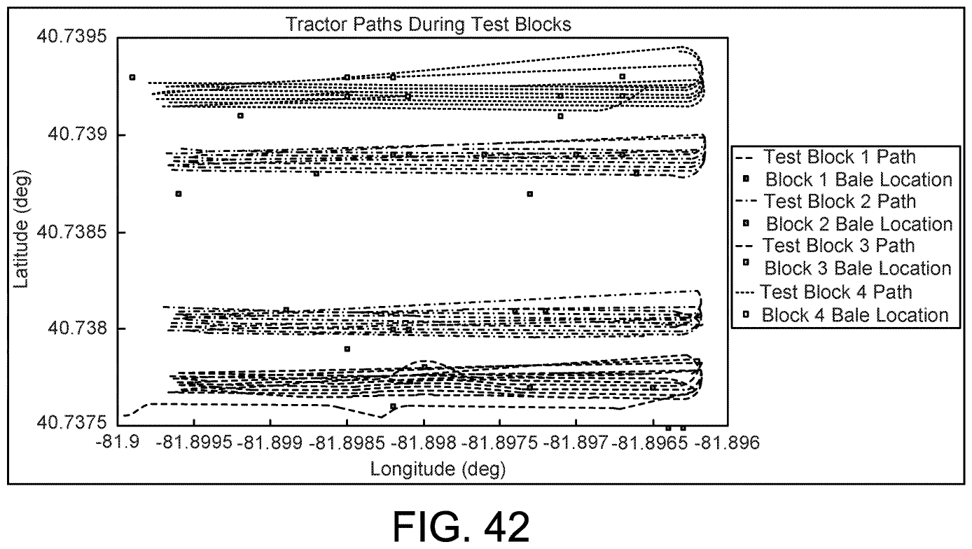

FIG. 44 shows a plot of the produced bale weights as a function of their length. A trendline was added to the graph with the intercept set at the origin. The regression model fitting these data was found to be Y=250.1X with a forced zero intercept. This implies that bale weight of the bale increases 250.1 lbs, for every foot added to the length of the bale. As seen in this figure the R2, or the coefficient of determination, is 0.9994. Based on the R2 value, it can be estimated that if the bales were produced at the maximum length allowed by the NH 340S+ of 98.43 inches, the bales would have an average weight of 2,050 lbs.

Data were recorded from the prototype whole-plant maize harvester using a CANCaseXL digital acquisition device paired with Vector Canoe software. The data were recorded as ASCII filetypes and then imported into Matlab for analysis. Messages were identified and decoded using the protocol outlined by SAE J1939 (SAE, 2021). CAN signals used for assessment of power requirements to operate the whole plant harvester are outlined in Table 7. Once the data was imported into MATLAB (2020 Version A), the signals needed were isolated and placed into a structure separated by file and message type. The MATLAB script then converted the data to United State Customary System (USCS) of units (i.e., gal/hr, mi/hr, lb-ft).

TABLE 7
Summary of CAN Signal Parameters, Units, PGN, Frequency and Resolution.

| | | | CAN | | |
|---|---|---|---|---|---|
| Parameter | | | PGN | Frequency | |
| Group Name | Signal | Units | Acronym | (Hz) | Resolution |
| Electronic Engine | Engine | rpm | EEC1 | 100 | 0.125 rpm per bit |
| Controller 1 | Speed | | | | |
| | Engine | % | EEC1 | | 0.125% per bit |
| | Torque | | | | |
| Fuel Economy | Fuel Rate | L/h | LFE | 10 | 0.05 L/h per bit |
| (Liquid) | | | | | |
| Rear Power Take | Rear PTO | rpm | RPTO | 10 | 0.125 rpm per bit |
| off Output Shaft | Speed | | | | |
| | Rear PTO | N/A | RPTO | | 4 states per 2 bit |
| | State | (on/off) | | | |
| Vehicle Position | Latitude | deg | VP | 0.2 | 10\hat{ }-7 deg per bit |
| | Longitude | deg | VP | | 10\hat{ }-7 deg per bit |
| Wheel-based | Wheel- | m/s | WBSD | 10 | 0.001 m/s per bit |
| Speed | based Speed | | | | |
| and Distance | | | | | |

The vehicle position data were then plotted to isolate the data pertaining to the individual treatment blocks. As previously stated, the data were first filtered by GNSS position and PTO state, removing any periods when the tractors was outside of the field boundary or when the PTO was off, to better represent the true performance requirements of the machine. Once the data were filtered, summary statistics were generated for each of the signals. Summary data are reported in Table 8 for metrics including fuel consumption, ground speed, engine speed, PTO speed, peak engine power, engine power, engine torque, and engine load.

Table 8 summarizes CAN data from the whole-plant harvester and tractor combination. From these data the single pass harvester required a minimum of 0.202 gal, and a maximum of 0.237 gal. of fuel to produce each bale. These values were based on operating the machine at a nominal engine speed of 1,850 rev./min, and PTO speed of 1,100 rev./min. per operator's settings of the tractor. In reality, the tractor engine speed operated at an average of 1,859 to 1,889 rev./min. and produced PTO speeds ranging from 1,162 to 1,219 rev./min. Average engine power ranged from 176 to 196 hp, while peak power momentarily reached as high as 550 HP.

TABLE 8
Whole Plant Maize Harvest CAN Data for Replicated Harvest Blocks.

| | | | Mean | Mean | Mean | Mean | Mean | Mean | Peak | Mean | Mean | Mean |
|---|---|---|---|---|---|---|---|---|---|---|---|---|
| | | Fuel | Fuel | Fuel | Fuel | Ground | PTO | Engine | Engine | Engine | Engine | Engine |
| | Bales | Used | Rate | Rate | Rate | Speed | Speed | Speed | Power | Power | Torque | Load |
| | Produced | (Gal) | (GPH) | (Gal/Ac) | (Gal/Bale) | (MPH) | (RPM) | (RPM) | (HP) | (HP) | (lb-ft) | (%) |
| Block 1 | 12 | 2.85 | 8.32 | 2.30 | 0.237 | 4.00 | 1,162 | 1,859 | 396 | 176 | 496 | 46.6% |
| Block 2 | 12 | 2.61 | 8.65 | 2.11 | 0.218 | 4.83 | 1,189 | 1,872 | 397 | 181 | 509 | 49.3% |
| Block 3 | 11 | 2.37 | 9.37 | 1.91 | 0.216 | 4.80 | 1,219 | 1,868 | 400 | 196 | 550 | 52.0% |
| Block 4 | 12 | 2.42 | 9.34 | 1.95 | 0.202 | 4.38 | 1,178 | 1,889 | 427 | 194 | 538 | 52.2% |

While these data are representative of cumulative fuel and power requirements of the prototype whole-plant harvester and the tractor, the data had to be segmented to estimate power and fuel were utilized by the prototype versus a standard baler. Therefore, multiple tests were conducted to isolate the metrics of the tractor operating independently, as well as driving the tractor at field speed while pulling the prototype harvester to establish the drawbar metrics. The tractor and harvester operated at three nominal speeds: 4.00, 4.38, and 4.80 mi./hr. During later testing a blunder occurred, and the harvest speed of 4.38 mph was recorded as a nominal 4.3 mph, instead of rounding to the correct 4.4 mph nominal. All tests from this point forward attempted to operate machinery at or near 4.0, 4.3, and 4.8 mph. This inherently causes conclusions drawn about performance at 4.38 mph to be less reliable less reliable, however an estimate can still be made as long as its validity is acknowledged.

In order to compare the harvest data, the same tractor was operated over soft ground. The tractor was operated at test ground speeds of 4.05, 4.24, and 4.77 mi./hr. for a distance of roughly 200 yds. These data are summarized in Table 9 which includes the metrics of engine speed, engine power, engine torque, and engine load.

TABLE 9
Tractor CAN Performance Data for Operation Over Soft Terrain.

| | Mean | Mean | Mean | Mean | Mean | Mean |
|---|---|---|---|---|---|---|
| | Fuel | Ground | Engine | Engine | Engine | Engine |
| | Rate | Speed | Speed | Power | Torque | Load |
| | (GPH) | (MPH) | (RPM) | (HP) | (lb-ft) | (%) |
| Test 1 | 5.626 | 4.05 | 1871 | 92.6 | 260 | 25.0 |
| Test 2 | 3.554 | 4.24 | 1875 | 71.8 | 201 | 19.4 |
| Test 3 | 4.475 | 4.77 | 1870 | 95.1 | 267 | 25.7 |

To determine the drawbar power and other metrics required to pull the baler, a tractor was operated over soft ground, both with and without the prototype baler. Collection of these data allowed for isolation of the drawbar power required to pull the whole plant harvester by looking at the CAN data differences with and without the baler. Once again, it was the tractor was operated at the same ground speeds as for the whole plant harvest. Tables 10 and 11 present these data with the same metrics as reported in Table 9.

TABLE 10
CAN Data without Whole Plant Harvester.

| | Mean | Mean | Mean | Mean | Mean | Mean |
|---|---|---|---|---|---|---|
| | Fuel | Ground | Engine | Engine | Engine | Engine |
| | Rate | Speed | Speed | Power | Torque | Load |
| | (GPH) | (MPH) | (RPM) | (HP) | (lb-ft) | (%) |
| Test 1 | 4.628 | 4.00 | 1873 | 74.4 | 209 | 24.3 |
| Test 2 | 4.655 | 4.29 | 1872 | 85.2 | 239 | 27.5 |
| Test 3 | 4.907 | 4.79 | 1870 | 88.9 | 250 | 28.7 |

TABLE 11
CAN Data with Whole Plant Harvester

| | Mean | Mean | Mean | Mean | Mean | Mean |
|---|---|---|---|---|---|---|
| | Fuel | Ground | Engine | Engine | Engine | Engine |
| | Rate | Speed | Speed | Power | Torque | Load |
| | (GPH) | (MPH) | (RPM) | (HP) | (lb-ft) | (%) |
| Test 1 | 5.614 | 4.00 | 1872 | 102.1 | 286 | 32.9 |
| Test 2 | 5.612 | 4.29 | 1877 | 88.4 | 247 | 28.5 |
| Test 3 | 5.492 | 4.79 | 1873 | 99.1 | 278 | 32.0 |

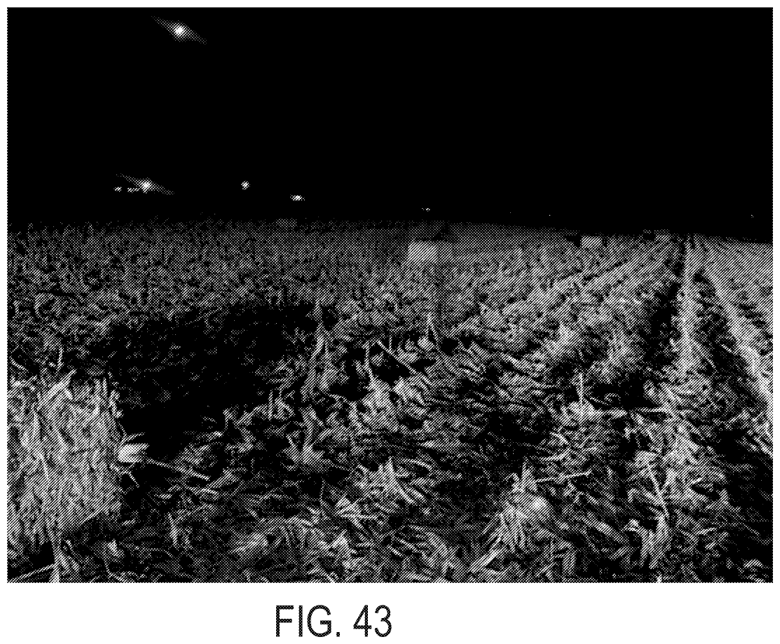

To estimate the power required for the hydraulic motor to operate the header, data from the Nebraska Tractor Test Laboratory (NTTL) was utilized. As part of the testing, NTTL evaluated the performance of the hydraulic system, these data are presented in FIG. 45. During harvest, the SCV's were set to full flow in an attempt to maximize the performance of the header. With harvest operations were underway, only one of the SCVs was used to power the header, all other SCVs were maintained in the off position. From the data presented in FIG. 45 it was estimated the header required 48.3 HP to operate.

To further compare the performance of the whole-plant harvest prototype, Tables 12 and 13 report engine power and fuel rate data, respectively. It is important to note the values reported in these tables are estimates, and while care was taken to ensure these data were as accurate or representative as possible, there are intrinsic errors that cannot be mitigated. Nevertheless, the data shows that the PTO driveline requires delivery of nominal mean power of 75.0 hp and with a peak power of 250 hp. In addition, the prototype harvester required from 2.70 to 5.79 gal./hr. of diesel fuel to perform harvest operations.

TABLE 12
Whole-Plant Harvester Power Requirements and Comparison
Power Comparison Data

| | | Deere | Deere | | | | | |
|---|---|---|---|---|---|---|---|---|
| | | 8370 | 8370 | | | | WP | WP |
| | | R + WP | R + WP | Deere | | Header | Harvester | Harvester |
| | Mean | Harvester | Harvester | 8370R | Mean | Motor | Mean | Peak |
| | Ground | Mean | Peak | Mean | Drawbar | Mean | PTO | PTO |
| | Speed | Power | Power | Power | Power | Power | Power | Power |
| | (MPH) | (HP) | (HP) | (HP) | (HP) | (HP) | (HP) | (HP) |
| Block 1 | 4.00 | 176 | 396 | 93 | 28 | 48 | 35 | 227 |
| Block 2 | 4.83 | 181 | 397 | 95 | 10 | 48 | 28 | 243 |
| Block 3 | 4.80 | 196 | 400 | 95 | 10 | 48 | 52 | 246 |
| Block 4 | 4.38 | 194 | 427 | 72 | 3 | 48 | 73 | 230 |

TABLE 13
Whole-Plant Harvester Fuel Rate Comparison.

| | | Deere 8370R + | | WP Harvester |
|---|---|---|---|---|
| | Mean | WP Harvester | Deere 8370R | Mean |
| | Ground Speed | Mean Fuel Rate | Mean Fuel Rate | Fuel Rate |
| | (MPH) | (GPH) | (GPH) | (GPH) |
| Block 1 | 4.00 | 8.32 | 5.63 | 2.70 |
| Block 2 | 4.83 | 8.65 | 4.48 | 4.18 |
| Block 3 | 4.80 | 9.37 | 4.48 | 4.89 |
| Block 4 | 4.38 | 9.34 | 3.55 | 5.79 |

One of the largest challenges with cellulosic ethanol production in the United States today is the logistics behind maize stover transport. Stover bale density is making it difficult to load over-the-road trucks to capacity. Assuming that the bales would be transported on a standard 53-foot flatbed semi-trailer, the trailer working width is limited to 102 in., and the overall height to 162 inches. Using nominal 3.0 ft by 4.0 ft rectangular bales produced by the prototype whole plant harvester, and assuming the bales could be stacked three high, the total trailer height would be 13 ft. assuming a standard trailer deck height of 48 in. (up to a maximum of 54 in. deck height and maximum loaded trailer heigh of 13 ft. and 6 in. Additionally, assuming a bale length of 5 ft and 5 in., these bales could be stacked two wide and nine long resulting in 54 bales loaded on each truck. Based on the aforementioned nominal bale size, each bale would have a volume of 61.5 ft3, bringing the total load volume to 3,321 ft3.

Typically, a semi-truck attached to a 53 ft trailer weighs around 35,000 lbs. The Ohio Department of Transportation has set the maximum weight for a loaded semi-truck and trailer at 80,000 lbs. without oversized load permits. This leaves roughly 45,000 lbs. available for load on the trailer. To fully load a trailer given this weight and the calculated individual volume of the bales, each bale would need to have a density of 13.55 lbs./ft3. The whole-plant harvester prototype was able to produce bales with an average density of 21.5 lbs./ft3., far exceeding the minimum required, and allowing semi-trailers to be overloaded. This makes transportation of the bales a much more cos-effective task.

Another key concept in the logistical solution provided by single-pass whole-plant harvest is the reduced machinery required to perform harvest operations. Traditionally, a combine harvests the maize grain and then dumps the grain into a wagon or cart pulled by a tractor. Later the stover is chopped using a pull-type mower or sickle-bar mounted on a tractor. The stover is raked and windrowed using a series of implements and a tractor. The stover is then baled using a round or large rectangular baler pulled behind a tractor. The bales are picked up with a telescopic handler or tractor with frontend loader for movement to the edge of field. By utilizing the prototype single-pass maize harvester, many of these operations are simplified into a single stage. Using this system, only a single tractor and implement combination (prototype whole plant harvester) is needed to produce whole plant bales. The farmer then has the choice on whether to use a different tractor for moving bales at harvest or utilize the tractor deployed for whole plant harvesting at a later point in time to reduce the equipment needed.

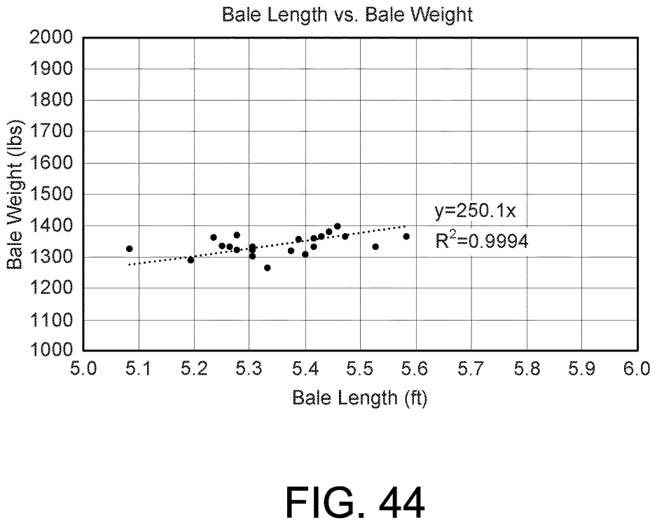

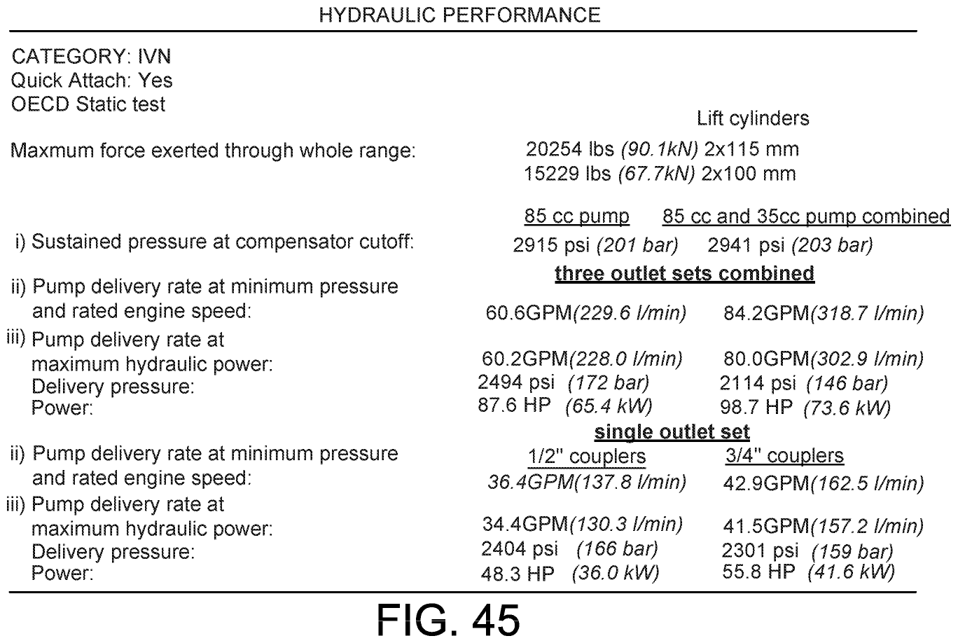

For single pass harvesting to be viable, the most effective solution if the same size tractor were able to be utilized to operate a stock baler as well as the whole-plant maize harvester 62. Table 12 shows that the prototype harvester required from 227 to 246 hp PTO during peak power demand periods, however due to the cyclic nature of baler power demand, the majority of baling operation requires lower power input. The majority of the time when “low demand” operations are occurring, the inertial mass of the baler flywheel is providing supplemental inertia to the system reducing the input torque and power required for the baler. The highest power requirement occurs for the plunger shortly after the stuffer mechanism is tripped to add material to the bale chamber. This loading pattern and concomitant power demand is illustrated in FIG. 46. This diagram shows a random 60 s. portion of harvest data extracted from the whole plant harvest treatment in Block 3. From the figure, the tractor produces a peak power of 200 to 250 hp through most of the period until the stuffer places whole crop material in the bale chamber ahead of the plunger stroke, which results in a peak power demand of 370 hp. As seen in FIG. 47, the torque requirement for the baler also follows a cyclic trend of the same pattern as the power requirements. This is due to the relationship between torque and horsepower which are directly related by speed and a conversion factor. Given that speed was nominally consistent throughout this testing, it would follow that the two figures should look nearly identical.

The cyclic loading in FIG. 46 can be easily analyzed so as to better understand the mechanical operations that are taking place throughout its' illustration. The local maximums that appear in this figure roughly every 1.25 sec represent the baler plunger stroke which happens at a rate of 48 strokes per minute. The absolute maximums occur when the fingers are tripped, moving a new flake into the bale chamber to be forced into a bale. The baler has the ability to predetermine the number of flakes and overall density of the formed bales. This means that flakes are not pushed into the bale chamber at steady rates as these flakes are varied based on crop yield and ground speed. This trend is show well in FIG. 47 but is annotated in FIG. 46. This illustration is broken down into four major sections, the first of which is a steady pattern of the flake being introduced to the bale on every third stroke of the plunger. Section two likely occurred in a section of field with much higher yield or stover content as the flake is kicked up after just the second stroke of the plunger. Section three briefly goes back to the same flake rate as section one before the biomass yield quickly drops off. In section four, the plunger strikes every fourth or even fifth time before the fingers finally move the flake into the bale chamber.

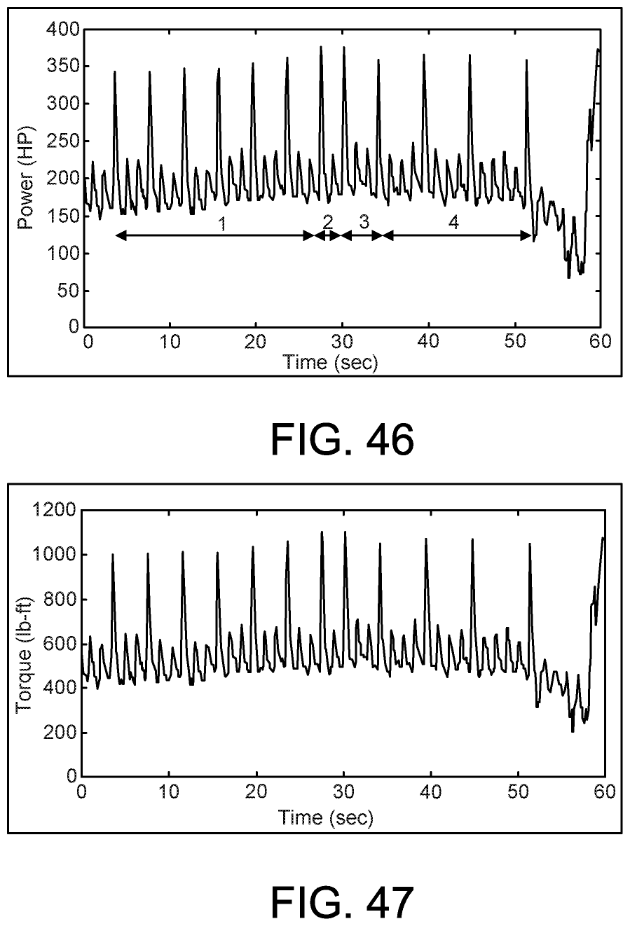

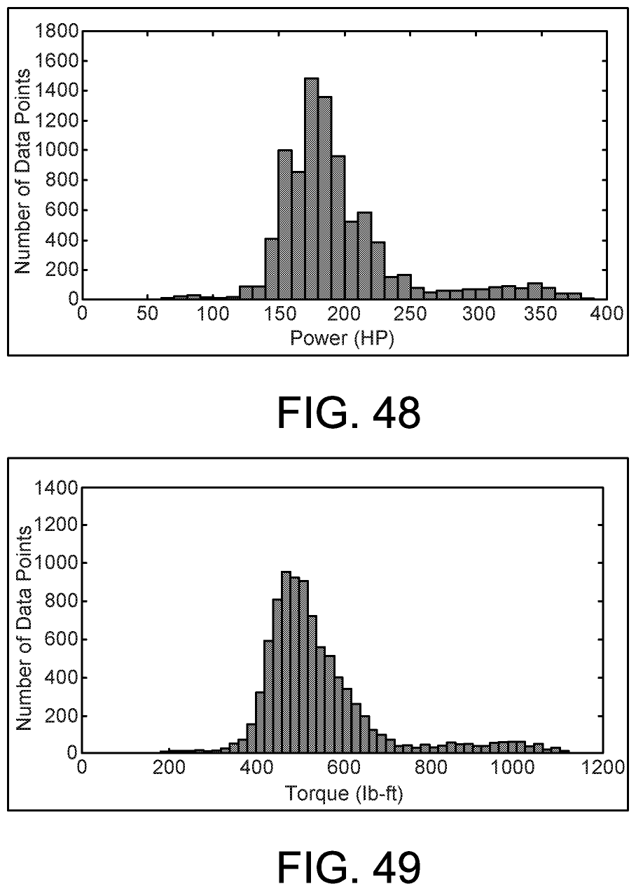

To further demonstrate the cyclic nature of the loading requirement of the baler, FIGS. 48 and 49 illustrate the distribution of power and torque produced over the full-length Block 3's harvest. As shown in FIG. 48, the majority of the time only 175-200 hp was required, while a small portion of the time required peak power. Similarly in FIG. 49 it can be seen that on average only 500 lb-ft of torque was required, while peaks rarely occurred as high as 1,100 lb-ft.

Based on PTO power requirements obtained from actual field tests, the hydraulic power required to operate header, a larger “recommended minimum size tractor” would be required to operate the whole plant maize harvester. While the nominal values are on the borderline of acceptable for the manufacturer suggested minimum size tractor, the peak values are well outside the operating range of these minimum sized machines.

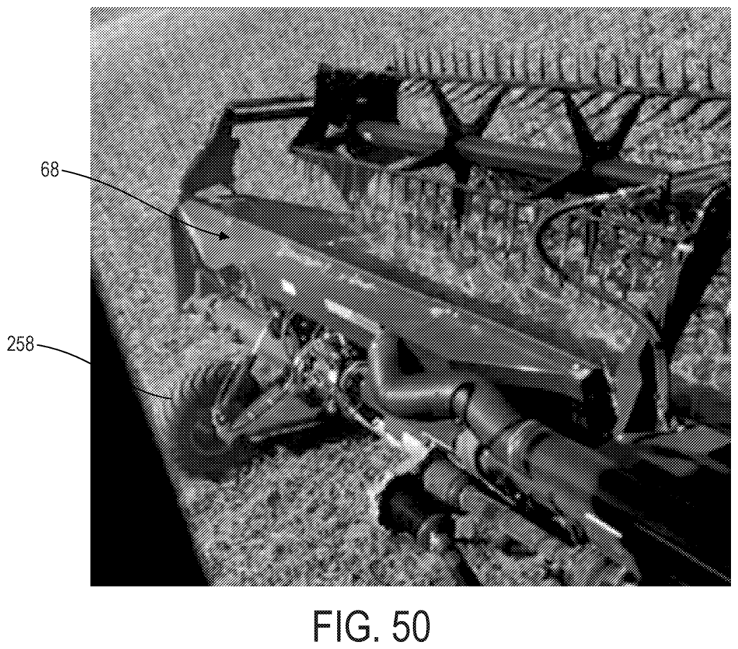

As shown in FIG. 50, in some implementations, outboard header support wheels 258 are attached to the maize forage harvester header 68 to alleviate harvester listing and potential hillside stability concerns at full offset. The addition of the outboard support wheels 258 may serve to better manage the weight transfer as a result of the harvester offset. In addition, the outboard wheels 258 swivel to account for end-of-field turns and/or harvesting non-linear planter passes.

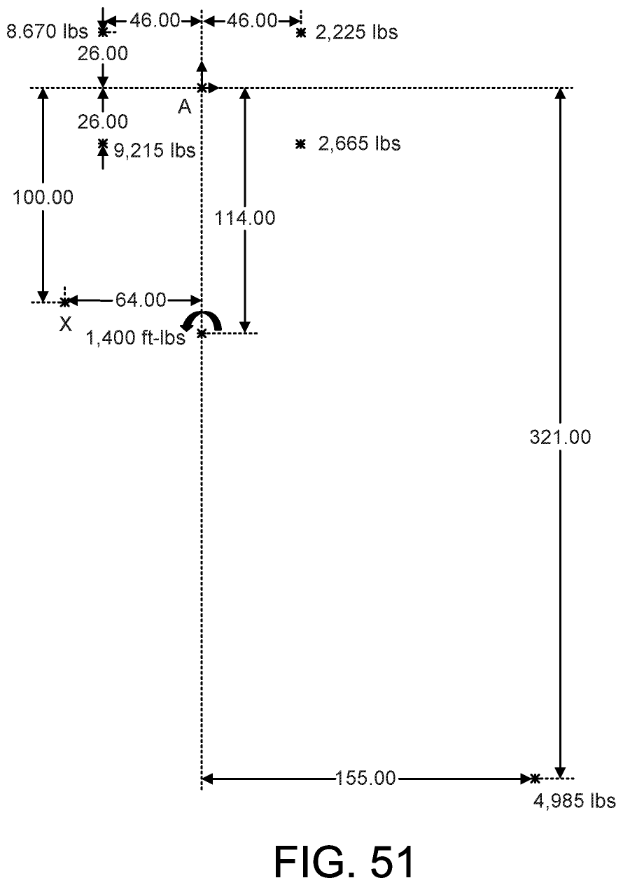

Based on the undercarriage weight distribution data from Table 4, a loading diagram was created and is shown in FIG. 51. This table summarizes the weight on each wheel and the hitch, as well as the slip-clutch torque of 1,400 ft. Ibs. at the baler flywheel. Additionally, a point X is present in the drawing where a load supporting tire would mount on the header. In this section the header frame has an exposed 6.00-inch square mechanical tube with 0.25-inch wall thickness to serve at the mounting point for an outboard wheel. To determine the load that the wheel would need to support at point X, a sum of moments calculation was performed at point A about the y-axis. This point A is the midpoint of the axles centered between the leaf springs. The locations of the loads are dimensioned in inches.

$${\sum }_{\text{?} +} MA = 0 = [ 2 , 225 lbs ( 46 in ) + 2 , 665 lbs ( 46 in ) + 4 , 985 ( 155 in ) - 8 , 670 lbs ( 46 in ) - 9 , 215 lbs ( 46 in ) - X ( 64 in ) ] ( \frac{1 ft}{12 in} ) + 1 , 400 ft - lbs$$

Equation 7. Whole plant harvester ground contact sum of moments.

Based on the solution derived from Eq. 7, a wheel located at point X would need to support 2,995 lbs in this simplified loading scenario. To verify this value, a pad scale was placed under the proposed mounting location and the header was blocked up using 6″×6″ wooden beams. The magnitude recorded during this testing was a requirement of 3,990 lbs force to level the baler frame. While this value is nearly 50% higher than expected, it still falls well within any ideal loading case for an agricultural implement wheel/tire combination.

While removing corn stover is very beneficial from a renewable energy standpoint, ultimately the end user, the farmer, will care primarily about grain yield. No ear loss data were recorded during harvest, as the primary goal was ensuring basic operational success of the whole plant harvester. However, based on video evidence recorded during harvest, it appears that the majority of grain loss at harvest can be attributed to the ear separating from the stalk shortly after initial contact with the header. The detached ears fell onto the rotating drums of the header and remained in place until knocked off by other stalks or ears. Perhaps the operation of the header at higher rotational speeds, it might be likely the detached ears would be forced into the baler throat with the rest of the harvested biomass.

The most direct way to address the ear loss problem may be resizing the hydraulic motor. Additionally, the power beyond SCV could power utilized to power the header drive hydraulic power as the power beyond function delivers a higher flow rate than standard SCV's. However, a more complex hydraulic circuit would be required to reduce the hydraulic pressure from the tractor to keep the motor within continuous operating flow and pressure parameters. Additionally, the power beyond SCV does is not controllable from the AFS Pro 700 or AFS Pro 1200 displays within the tractor cab. Therefore, with safety in mind, a PWM actuated flow control valve would be needed to control hydraulic flow and pressure from the power beyond valve.

While the whole-plant maize harvester 62 offers significant potential for integrated biorefinery feedstock logistics, the same harvester may have applicability to other crops.

One of the more unique crops that might be suited to whole plant harvesting couple be cotton. Similar to the thought process behind the logistical implications of sending whole plant maize bales to a bioconversion facility, whole plant cotton bales could be delivered and stored at cotton gins. For this system to be viable, the gin would have to separate the seed cotton from the bowl and other biomass prior to introduction to a traditional gin. Wrapping cotton bales with plastic could extend the storage life of the crop. Currently, cotton gins operate for only a few months of the year coinciding with the start of cotton harvest. Lon-term storage of high-density cotton bales may extend the operating periods of gins thereby amortizing gin costs over a greater number of cotton bales per year. A thorough technoeconomic analysis of this harvest strategy might provide adequate justification for additional work in this area.

Similar to the benefits of harvesting and baling maize or cotton, the whole plant harvester might have more immediate use with forage and silage crops. Sorghum, alfalfa, and miscanthus crops are traditionally baled at harvest. Deployment of the whole plant harvest strategy for other crops might be appealing to many farmers as this might reduce overall equipment inventories on farmers by utilizing a single harvester for multiple crops. The same equipment might also find use with emerging crops such as industrial hemp.

For purposes of this description, certain advantages and novel features of the aspects and configurations of this disclosure are described herein. The described methods, systems, and apparatus should not be construed as limiting in any way. Instead, the present disclosure is directed toward all novel and nonobvious features and aspects of the various disclosed aspects, alone and in various combinations and sub-combinations with one another. The disclosed methods, systems, and apparatus are not limited to any specific aspect, feature, or combination thereof, nor do the disclosed methods, systems, and apparatus require that any one or more specific advantages be present or problems be solved.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

Features disclosed in this specification (including any accompanying claims, abstract, and drawings), and/or all of the steps of any method or process so disclosed, may be combined in any combination, except combinations where at least some of such features and/or steps are mutually exclusive. The claimed features extend to any novel one, or any novel combination, of the features disclosed in this specification (including any accompanying claims, abstract, and drawings), or to any novel one, or any novel combination, of the steps of any method or process so disclosed.

As used in the specification and the appended claims, the singular forms “a”, “an”, and “the” include plural referents unless the context clearly dictates otherwise. Ranges may be expressed herein as from “about” one particular value, and/or to “about” another particular value. When such a range is expressed, another aspect includes from the one particular value and/or to the other particular value. Similarly, when values are expressed as approximations, by use of the antecedent “about”, it will be understood that the particular value forms another aspect. It will be further understood that the endpoints of each of the ranges are significant both in relation to the other endpoint, and independently of the other endpoint. The terms “about” and “approximately” are defined as being “close to” as understood by one of ordinary skill in the art. In one non-limiting aspect the terms are defined to be within 10%. In another non-limiting aspect, the terms are defined to be within 5%. In still another non-limiting aspect, the terms are defined to be within 1%.

The terms “coupled”, “connected”, and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic. For example, circuit A communicably “coupled” to circuit B may signify that the circuit A communicates directly with circuit B (i.e., no intermediary) or communicates indirectly with circuit B (e.g., through one or more intermediaries).

Certain terminology is used in the following description for convenience only and is not limiting. The words “right”, “left”, “lower”, and “upper” designate direction in the drawings to which reference is made. The words “inner” and “outer” refer to directions toward and away from, respectively, the geometric center of the described feature or device. The words “distal” and “proximal” refer to directions taken in context of the item described and, with regard to the instruments herein described, are typically based on the perspective of the practitioner using such instrument, with “proximal” indicating a position closer to the practitioner and “distal” indicating a position further from the practitioner. The terminology includes the above-listed words, derivatives thereof, and words of similar import.

Throughout the description and claims of this specification, the word “comprise” and variations of the word, such as “comprising” and “comprises”, means “including but not limited to”, and is not intended to exclude, for example, other additives, components, integers or steps. “Exemplary” means “an example of” and is not intended to convey an indication of a preferred or ideal aspect. “Such as” is not used in a restrictive sense, but for explanatory purposes.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention.

What is claimed is:

1. A whole-plant harvester comprising:
a swing hitch including
a box section configured to couple to a tractor,
a frame bracket, and
a main beam rigidly coupled to the box section and pivotably coupled to the frame bracket;
a baler rigidly coupled to the frame bracket, the baler including baler intake portion for intaking whole-plant crops and a baler output portion for outputting bales of whole-plant crops;
an upper header mount coupled to the baler;
a linear actuator coupled to the baler; and
a harvester header pivotably coupled to the upper header mount and coupled to the linear actuator, the harvester header including one or more drums for cutting and gathering whole-plant crops and a head output portion for outputting the cut and gathered whole-plant crops,
wherein the harvester header is coupled to the baler such that the head output portion feeds whole-plant crops directly into the baler intake portion.

2. The whole-plant harvester of claim 1, wherein the baler intake portion is disposed at a distance from one or more wheels such that the baler intake portion is disposed at the same height as the head output portion relative to the one or more wheels.

3. The whole-plant harvester of claim 1, wherein the upper header mount includes a hinge coupled to the baler.

4. The whole-plant harvester of claim 1, wherein the whole plant harvester is arrangeable in a travel arrangement and an offset arrangement for harvesting.

5. The whole-plant harvester of claim 4, wherein the baler is offset from the tractor when the whole-plant harvester is in the offset arrangement.

6. The whole-plant harvester of claim 1, further comprising a driveline coupled to the swing hitch and configured to transmit mechanical energy from a power-take-off of the tractor to the baler and the harvester header.

7. The whole-plant harvester of claim 6, wherein the driveline includes a power-take-off bearing mount coupled to the power-take-off of the tractor, a tractor side swivel gearbox mechanically coupled to the power-take-off bearing mount, and an implement side swivel gearbox mechanically coupled to the tractor side swivel gearbox.

8. The whole-plant harvester of claim 7, wherein the tractor side swivel gearbox is coupled to the implement side swivel gearbox by a gear drive shaft supported by a plurality of hanger bearings.

9. The whole-plant harvester of claim 1, wherein the frame bracket includes side plates providing space for rotation of the baler relative to the swing hitch, and a plurality of horizontal plates rotatably coupled to the swing hitch.

10. The whole-plant harvester of claim 1, wherein the swing hitch is configured to rotate relative to the baler by up to forty-five degrees.

11. The whole-plant harvester of claim 1, wherein the box section includes a plurality of mounting holes configured to receive a pintle hitch configured to couple to the tractor.

12. The whole-plant harvester of claim 11, wherein the plurality of mounting holes provide up to six inches of vertical height adjustment.

13. The whole-plant harvester of claim 1, wherein the baler includes a baler undercarriage and a baler frame that is lifted relative to the baler undercarriage by at least twenty inches.

14. The whole-plant harvester of claim 1, wherein the upper header mount includes a mechanical tube shaft rigidly coupled to the baler and a journal bearing rotatably mounted to the mechanical tube shaft, and
wherein the harvester header is coupled to the journal bearing so that the harvester header rotates about the mechanical tube shaft.

15. The whole-plant harvester of claim 1, wherein the linear actuator includes a hydraulic cylinder pivotably coupled between the baler and the harvester header to rotatably raise and lower the harvester header relative to the baler.

16. A swing hitch for a whole-plant harvester, the swing hitch comprising:
a box section including a plurality of mounting holes configured to receive a pintle hitch configured to couple to a tractor;
a main beam rigidly coupled to the box section; and
a frame bracket configured to engage a baler, the frame bracket including side plates providing space for rotation of the baler relative to the main beam, and a plurality of horizontal plates rotatably coupled to the swing hitch.

17. The swing hitch of claim 16, further comprising a driveline coupled to the swing hitch and configured to transmit mechanical energy from a power-take-off of the tractor to the baler and a harvester header.

18. The swing hitch of claim 17, wherein the driveline includes a power-take-off bearing mount coupled to the power-take-off of the tractor, a tractor side swivel gearbox mechanically coupled to the power-take-off bearing mount, and an implement side swivel gearbox mechanically coupled to the tractor side swivel gearbox.

19. A whole-plant harvester comprising:
a swing hitch including
a box section including a plurality of mounting holes configured to receive a pintle hitch configured to couple to a tractor,
a main beam rigidly coupled to the box section, and
a frame bracket including side plates and a plurality of horizontal plates rotatably coupled to the swing hitch;
a baler rigidly coupled to the side plates of the frame bracket so that the baler can rotate relative to the main beam, the baler including baler intake portion for intaking whole-plant crops and a baler output portion for outputting bales of whole-plant crops; and
a harvester header pivotably coupled to the swing hitch and movable vertically relative to the baler, the harvester header including one or more drums for cutting and gathering whole-plant crops and a head output portion for outputting the cut and gathered whole-plant crops.

20. The whole-plant harvester of claim 19, further comprising a superstructure rigidly coupled to the frame bracket and the baler to inhibit damage to the baler during operation.
